(19) United States
(12) Patent Application Publication
(10) Pub. No.: US 2026/0079139 A1
(43) Pub. Date: Mar. 19, 2026

(54) FAILOVER OPERATION MODE FOR LIQUID CHROMATOGRAPHY SYSTEMS

(71) Applicant: Dionex Softron GmbH, Germering (DE)

(72) Inventors: Martin Rendl, Munich (DE); Anne Morgenstern, Gilching (DE)

(21) Appl. No.: 18/954,749

(22) Filed: Nov. 21, 2024

Related U.S. Application Data
(60) Provisional application No. 63/696,005, filed on Sep. 18, 2024.

(51) Int. Cl. G01N 30/86; B01D 15/14; B01D 15/18; G01N 30/02; G01N 30/32

(52) U.S. Cl. CPC G01N 30/86; B01D 15/14; B01D 15/1885; G01N 30/32; G01N 2030/027; G01N 2030/326

(57) ABSTRACT

The present invention relates to a method in a liquid chromatography system comprising a first separation column, a second separation column, a separation pump upstream the separation columns and a detector downstream the separation columns, the method comprising: detecting a failover activation event relating to one of the separation columns, said separation column being a non-operational column, while the other an operational column; operating the liquid chromatography system in a failover operation mode, after detecting the failover activation event. Operating the liquid chromatography system in the failover operation mode comprises: allowing a fluid connection between the separation pump, the operational column and the detector and preventing a fluid connection between the non-operational column and the detector. The present invention also relates to a system for liquid chromatography.

### CROSS REFERENCE TO RELATED APPLICATION

This application claims the benefit of U.S. Provisional Application Ser. No. 63/696,005, filed Sep. 18, 2024, which is incorporated by reference in its entirety.

### BACKGROUND

The present invention lies in the field of liquid chromatography and, more particularly, in the field of high-performance liquid chromatography.

Liquid chromatography (LC) and in particular high-performance liquid chromatography (HPLC) is a widely used technique in various industries, including pharmaceuticals, environmental analysis, food and beverages, and forensics. It relates to an analytical method to separate a sample into its constituent parts and then detect the constituents. For example, the respective proportions may be quantified. Generally, in liquid chromatography, separation between said respective proportions is achieved. A liquid chromatography system can typically comprise at least one pump, a sample providing means, e.g. an autosampler, at least one separation column and a detector.

In order to perform liquid chromatography, a sample is added to one or more solvents and is subjected to flow, by means of the action of the pump, through the separation column and towards the detector. The pump that can be utilized in a liquid chromatography system may deliver a gradient into the separation column. That it, the composition of a mobile phase, i.e. the solvent, going through the separation column may be changed over time using the separation pump. The time it takes for different constituents of a sample to pass through the separation column varies based on factors including their adherence to the column, the solvent, the solvent's flow rate, and its pressure. Typically, the stronger the interaction between a constituent and the separation column, the longer it takes to pass through. This variation enables the determination and analysis of the sample's constituents.

As the demand, e.g., for increased throughput may be important, the complexity of liquid chromatography systems may also increase. A tandem chromatography system generally comprises more than one separation column. The utilization of more than one separation column in a tandem chromatography system may reduce the time to result as well as costs, by parallelizing certain steps of the method for using a tandem chromatography system. For example, more than one column can be concurrently utilized, therefore, in an optimal case, doubling the throughput.

As an example, in a tandem chromatography system, a plurality of separation columns may me embedded in the same system and each separation column, within said plurality of separation columns, may be used in a sequential workflow, i.e. one after the other. As a consequence, chromatograms are obtained sequentially, i.e. one after the other, thus increasing the throughput of the system. However, the above-mentioned workflow may not assure that the quality of the analysis is uncompromised, but may merely concentrate on increasing the throughput of the system.

In addition to throughput, robustness can also be important in LC, due to its impact on the reliability and accuracy of analytical results. It can be advantageous that LC systems consistently deliver accurate and reproducible results, as any deviations or inconsistencies can have significant consequences.

One key reason why robustness can be important in LC is its impact on data quality. Robust LC systems can be designed to minimize factors that can introduce variability or errors in the analysis. This can include factors such as temperature fluctuations, changes in mobile phase composition, column performance, detector sensitivity, and sample preparation. By maintaining consistent and stable conditions, robust LC systems can ensure that the obtained results can be reliable and trusted for decision-making processes.

In the pharmaceutical industry, robustness can be particularly critical. LC can be extensively used in various stages of drug development, including research and development, quality control, and manufacturing. In these applications, the accuracy and reliability of LC results can directly impact patient safety and the efficacy of pharmaceutical products. A robust LC system can ensure that the analysis of drug compounds is consistent, reproducible, and in compliance with regulatory requirements.

Robustness can also be advantageous in LC for maintaining productivity and efficiency. Unplanned downtime or frequent system failures can significantly disrupt laboratory operations, leading to delays in analysis, decreased throughput, and increased costs. Robust LC systems can be configured to minimize downtime, with features such as reliable pumps, detectors, and autosamplers, as well as robust software for system control and data analysis. By minimizing system failures and downtime, robust LC systems can contribute to increased laboratory productivity and efficiency. Additionally, interrupted analysis may have a significant negative impact for customers in the case of extremely low sample amounts e.g., for single cell analytics. In this case there might not be a sufficient amount of sample left to repeat the analysis for a second time. Hence, avoiding sample loss can be a necessity.

Moreover, robustness in LC can be advantageous for user convenience and ease of operation. LC systems are now being used in a variety of laboratories, including those with users who may have limited experience or training in chromatography. Thus, it can be advantageous for LC systems to be user-friendly, with intuitive interfaces, clear instructions, and automated features that can simplify operation and minimize the risk of user errors. Thus, even users with limited expertise can successfully operate the LC system and obtain reliable results.

Another aspect of robustness in LC can be the availability of technical support and maintenance. Even with robust systems, occasional issues or malfunctions may arise. In such cases, having access to fast and efficient technical support can be beneficial for minimizing downtime and resolving problems effectively. Robust LC systems can be backed by manufacturers or service providers who offer comprehensive technical support, including troubleshooting guides, customer helplines, and on-site assistance. Thus, any issues can be addressed promptly, minimizing the impact on laboratory operations.

In conclusion, robustness can be of paramount importance in LC, particularly in HPLC, due to its impact on data quality, productivity, user convenience, and overall reliability of the analysis. Robust HPLC systems can provide consistent and reproducible results, which may be particularly critical in industries such as pharmaceuticals where patient safety and product efficacy are important. Additionally, robust systems can minimize downtime, improve laboratory productivity, and should be designed to be user-friendly, accommodating users with limited experience. Access to reliable technical support can further enhance the robustness of LC systems, ensuring that any issues can be promptly resolved. Ultimately, robustness in HPLC can contribute to the overall success and efficiency of analytical laboratories across various industries.

Thus, there is a need for robust liquid chromatography systems.

In a first aspect, the present invention relates to a method in a liquid chromatography system comprising a first separation column, a second separation column, a separation pump upstream the separation columns and a detector downstream the separation columns. The method comprises detecting a failover activation event relating to one of the separation columns, said separation column being a non-operational column, while the other an operational column. The method further comprises operating the liquid chromatography system in a failover operation mode, after detecting the failover activation event. Operating the liquid chromatography system in the failover operation mode comprises allowing a fluid connection between the separation pump, the operational column and the detector and preventing a fluid connection between the non-operational column and the detector.

Throughout the description, the first separation column and the second separation column can be jointly referred to as separation columns. Moreover, for the sake of brevity the separation column(s) may also be referred to as column(s). Further still, for the sake of brevity, liquid chromatography may be referred to by its acronym LC.

The present invention can thus leverage an inherent redundancy of multiple available columns in liquid chromatography (LC) systems, such as, in a high-performance liquid chromatography (HPLC) system, to enhance robustness of said systems. The present invention may particularly be advantageous for use in tandem LC systems, wherein multiple columns are utilized.

On the one hand, the present invention can detect a failover activation event, wherein one of the separation columns can become non-operational. Instead of the entire LC system becoming non-operational, the present invention allows operation of the LC system in a failover operation mode wherein the other operational column(s) can be used to perform liquid chromatography.

Detecting the failover activation event can comprise detecting a flow resistance of one of the separation columns exceeding a predefined resistance range. That is, the method may comprise monitoring, e.g., with a controller, for each of the separation columns a respective flow resistance whether it is within the predefined resistance range or whether it exceeds it. The predefined resistance range can be defined such that it can correspond to a resistance range expected to be provided by the separation columns during normal operation. It will be understood, that for each separation column, a respective predefined resistance range can be provided. However, for identical separation columns the same predefined resistance range can be used. Furthermore, the flow resistance may become larger than a maximum value in the predefined resistance range or it may become smaller than a minimum value in the predefined resistance range. The former may indicate a blockage of the respective column, whereas the latter may indicate a bleeding of column materials (i.e., loss of solid phase). In any case, the respective column becomes non-operational.

Detecting the failover activation event can comprise detecting a pressure value of one of the separation columns exceeding a predefined pressure range. That is, the method may comprise monitoring, e.g., with a controller, for each of the separation columns a respective pressure value whether it is within the predefined pressure range or whether it exceeds it. The predefined pressure range can be defined such that it can correspond to a pressure range expected to be provided by the separation columns during normal operation. It will be understood, that for each separation column, a respective predefined pressure range can be provided. However, for identical separation columns the same predefined pressure range can be used. Furthermore, the pressure value may become larger than a maximum value in the predefined pressure range or it may become smaller than a minimum value in the predefined pressure range. The former may indicate a blockage of the respective column, whereas the latter may indicate a bleeding of column materials (i.e., loss of solid phase). In any case, the respective column becomes non-operational.

Detecting the failover activation event can comprise detecting the failover activation event while a flow is provided from said column towards the detector.

Operating the liquid chromatography system in the failover operation mode can comprise loading samples into the operational column and preventing loading samples into the non-operational column. In other words, during the failover operation mode, sample can be loaded only into the operational column. This can be particularly advantageous for avoiding sample loss and for ensuring that each sample can be analyzed properly.

Operating the liquid chromatography system in the failover operation mode can comprise controlling a pressure in the non-operational column. For example, controlling a pressure in the non-operational column can comprise maintaining a constant pressure in the non-operational column. It will be understood, that controlling a pressure in the non-operational column can be only one exemplary way of operating the non-operational column. However, as it will also become apparent, in some embodiments this can be advantageous as it may allow a seamless switch from a tandem operation of the separation columns to the failover operation mode.

In the failover operation mode, the non-operational column can be fluidly connected to a waste downstream the non-operational column and the operational column can be fluidly connected to the detector. That is, during the failover operation mode, only the operational column can be connected to the detector. Thus, only flows from the operational column can be analyzed. On the other hand, material that may flow through the non-operation column can be directed to a waste, thus avoiding contamination of the LC system.

Throughout the description, the term “fluidly connected” can refer to a connection that can allow fluid flow. For example, component A can be fluidly connected with component B if a fluid may flow from A to B (or vice-versa). Similarly, the term “fluidly connecting” can refer to establishing a fluid connection such that fluid may flow. For example, fluidly connecting component A with component B can establish a fluid connection between A and B such that a fluid may flow from A to B (or vice-versa).

In the failover operation mode, fluid connections downstream the separation columns can be maintained fixed.

The liquid chromatography system can comprise a second pump upstream the separation columns. The second pump can be advantageous for allowing a tandem operation of the LC system. That is, typically a second pump can be inherent in a tandem LC system. In general, a second pump may be advantageous as it may be utilized to perform, inter alia, injection of samples into the LC system and/or washing of the chromatography system. Thereby, the second pump may relieve the separation pump from said tasks, such that the separation pump may only be used for providing a flow from the separation columns to the detector.

Throughout the description the separation pump and the second pump can be jointly referred to as pumps.

Operating the liquid chromatography system in the failover operation mode can comprise cyclically switching each of the pumps between being fluidly connected to the non-operational column and to the operational column. Thus, in one configuration the separation pump can be fluidly connected to the non-operational columns and the second pump can be connected to the operational column whereas in another configuration the separation pump can be fluidly connected to the operational columns and the second pump can be connected to the non-operational column. The method may comprise cyclically switching between these two configurations while the system is in the failover operation mode. Thus, the operational column can be fluidly connected to each of the pumps. This can be advantageous as it can allow the operational column to be washed via the second pump and to be utilized for chromatographic separation via the separation pump.

Operating the liquid chromatography system in the failover operation mode can comprise operating each of the pumps in a predetermined controlled mode when fluidly connected to the non-operational column. This can allow for a safe and predictable operation of the pumps when connected to the non-operational column.

The predetermined controlled mode can be a pressure-controlled mode, in which each pump can be operated to control a pressure in the non-operational column, preferably to maintain a constant pressure in the non-operational column. A pressure-controlled mode can be particularly advantageous as it can allow for a particularly safe and predictable operation of the pumps when connected to the non-operational column. For example, in case of complete blockage of the non-operational column the flow will be zero. The pressure-controlled mode may also allow for more seamless transitions between being connected to the non-operational and operational column—as the fluid connections can be maintained at a predetermined pressure, thus minimizing pressure surges during connection switches.

However, it will be understood, that the pressure-controlled mode, while advantageous, is merely exemplary and that other modes may also be utilized, such as, e.g., a flow-controlled mode, where the flow through the non-operational column is controlled, e.g., to be constant.

Operating the liquid chromatography system in the failover operation mode can comprise operating the separation pump to supply a flow from the operational column to the detector and operating the second pump to supply a flow from the operational column to a waste. In other words, during the failover operation mode the separation pump can be utilized to perform chromatographic separation via the operational column and the second pump can be utilized to wash the operational column, i.e., to prepare the operational column for the next sample.

Operating the liquid chromatography system in the failover operation mode can comprise operating the separation pump in a predetermined controlled mode, when fluidly connected to the non-operational column and to supply a flow from the operational column to the detector, when fluidly connected to the operational column.

Operating the separation pump in the predetermined controlled mode can comprise operating the separation pump in a pressure-controlled mode, in which the separation pump can be operated to control a pressure in the non-operational column, preferably to maintain a constant pressure in the non-operational column.

Operating the liquid chromatography system in the failover operation mode can comprise operating the second pump in the predetermined controlled mode, when fluidly connected to the non-operational column and to supply a flow from the operational column to a waste, when fluidly connected to the operational column.

Operating the second pump in the predetermined controlled mode can comprise operating the second pump in a pressure-controlled mode, in which the second pump can be operated to control a pressure in the non-operational column, preferably to maintain a constant pressure in the non-operational column.

Operating the liquid chromatography system in the failover operation mode can comprise operating the liquid chromatography system in a first failover configuration; switching, at a first failover switching time, the liquid chromatography system from the first failover configuration to a second failover configuration; operating the liquid chromatography system in the second failover configuration until a second failover switching time. The first failover configuration and the second failover configuration can be different configurations of the LC system. For example, they can differ by at least one fluid connection. Additionally or alternatively, they may also differ by at least one operation mode of the separation pump and/or of the second pump.

The method can comprise switching, at the second failover switching time, the liquid chromatography system from the second failover configuration to the first failover configuration. Thus, the first failover configuration and the second failover configuration may form a loop. This can be particularly advantageous for allowing operation of the LC system during the failover operation mode according to a cyclic process.

Operating the liquid chromatography system in the failover operation mode can comprise cyclically switching between the first and the second failover configuration. That is, the LC system may be switched back and forth between the first failover configuration and the second failover configuration.

Switching the liquid chromatography system between the first failover configuration and the second failover configuration can be performed with a controller. That is, during the failover operation mode, the LC system may be switched between the different configurations automatically via the controller, i.e., without the need of manual intervention.

In the first failover configuration, the separation pump can be fluidly connected to the non-operational column and can be operated in a predetermined controlled mode. This way the operational column can be available for washing and/or preparation for the next sample analysis. Furthermore, as it will become apparent further below, in some embodiments, this can facilitate a seamless transition to the first failover configuration, particularly the first time the LC system enters the failover operation mode.

Operating the separation pump in the predetermined controlled mode can comprise operating the separation pump in a pressure-controlled mode, in which the separation pump can be operated to control a pressure in the non-operational column, preferably to maintain a constant pressure in the non-operational column.

In the second failover configuration, the separation pump can be fluidly connected to the operational column and can be operated to supply a flow from the operational column to the detector. This can allow analyzing a sample injected to the LC system while the system is in the first failover configuration.

In the first failover configuration, the second pump can be fluidly connected to the operational column and can be operated to supply a flow from the operational column to a waste. This can allow the operational column to be washed and/or prepared for the next sample analysis via the second pump. Furthermore, as it will become apparent further below, in some embodiments, this can facilitate a seamless transition to the first failover configuration, particularly the first time the LC system enters the failover operation mode.

In the second failover configuration, the second pump can be fluidly connected to the non-operational column and can be operated in the predetermined controlled mode. This way the operational column can be available to be subjected to a flow via the separation pump.

Operating the second pump in the predetermined controlled mode can comprise operating the second pump in a pressure-controlled mode, in which the second pump can be operated to control a pressure in the non-operational column, preferably to maintain a constant pressure in the non-operational column.

The method can comprise operating the liquid chromatography system in an intermediate failover operation mode after detecting the failover activation event and before operating the liquid chromatography system in the failover operation mode. This can be advantageous as it may allow a seamless transition of the system into the failover operation mode by preparing the system for entering the failover operation mode. In the intermediate failover operation mode, processes or cycles of the LC system that are incomplete at the detection of the failover activation event may be completed. Alternatively or additionally, in the intermediate failover activation mode the system may be switched to a predetermined configuration which can allow seamless transition of the LC system into the failover operation mode.

Thus, instead of switching the LC system directly into the failover operation mode, upon detecting the failover activation event, the present invention may firstly switch the LC system into the intermediate failover operation mode. This can mitigate switching the system from an unpredictable configuration to the failover operation mode and can rather enable switching the system from a predetermined configuration to the failover operation mode.

The intermediate failover operation mode can be particularly advantageous for avoiding sample loss.

In the intermediate failover operation mode, the liquid chromatography system can be operated such that loading of a sample into the non-operational column can be prevented. This can be advantageous for avoiding sample loss.

In the intermediate failover operation mode, the liquid chromatography system can be operated such that injecting a sample from a reservoir into the liquid chromatography system can be prevented. Again, this can be advantageous for avoiding sample loss.

In other words, during the intermediate failover operation mode, any sample present in the LC system when the failover activation event occurs, may be analyzed and no new sample may be introduced. This can allow completing, during the intermediate operation mode, any ongoing processes or cycles, without starting new ones. As a result, a seamless and safe transition to the failover operation mode can be achieved.

In the intermediate failover operation mode, the liquid chromatography system can be operated such that supplying a flow from the non-operational column to the detector can be prevented. This can be advantageous to avoid obtaining inaccurate results and/or damaging the detector.

Operating the liquid chromatography system in the intermediate failover operation mode can comprise operating the liquid chromatography system in a first intermediate failover configuration; switching, at a first intermediate failover switching time, the liquid chromatography system from the first failover configuration to a second intermediate failover configuration; operating the liquid chromatography system in the second intermediate failover configuration until a second intermediate failover switching time. The first intermediate failover configuration and the second intermediate failover configuration can be different configurations of the LC system. For example, they can differ by at least one fluid connection. Additionally or alternatively, they may also differ by at least one operation mode of the separation pump and/or of the second pump.

The intermediate failover operation mode can comprise operating the liquid chromatography system only once in each of the first and second intermediate failover configurations. Thus, the intermediate failover operation mode can facilitate completing existing processes and/or cycles without starting new ones.

Switching the liquid chromatography system from the first intermediate failover configuration to the second intermediate failover configuration can be performed with a controller. That is, during the intermediate failover operation mode, the LC system may be switched between the different configurations automatically via the controller, i.e., without the need of manual intervention.

In the first intermediate failover configuration, the separation pump can be fluidly connected to the operational column and can be operated to supply a flow from the operational column to the detector. This can allow analyzing a sample already injected in the LC system when the failover activation event occurs.

Operating the separation pump in the first intermediate failover configuration to supply a flow from the operational column to the detector can comprise providing a gradient.

In the first intermediate failover configuration, the second pump can be fluidly connected to the non-operational column and can be operated to supply a flow from the non-operational column to a waste. That is, the non-operational column may be washed via the second pump. It will be understood, that said flow may not necessarily reach the waste, e.g., in case of a complete blockage of the non-operational pump.

In the second intermediate failover configuration, the second pump can be fluidly connected to the operational column and preferably can be operated to supply a flow from the operational column to the detector. Connecting the second pump to the operational column can be advantageous as it can allow preparing the operational column for a subsequent sample analysis that can be performed during the failover operation mode. The second pump being fluidly connected to the operational column coincides with the first failover configuration, thus, allowing for a seamless transition to the failover operation mode.

Operating the second pump in the second intermediate failover configuration to supply a flow from the operational column to the detector can comprise providing a gradient.

In the second failover configuration, the separation pump can be fluidly connected to the non-operational column and can be preferably operated in a predetermined controlled mode. The separation pump being fluidly connected to the non-operational column coincides with the first failover configuration, thus, allowing for a seamless transition to the failover operation mode.

Operating the separation pump in the predetermined controlled mode can comprise operating the separation pump in a pressure-controlled mode, in which the separation pump can be operated to control a pressure in the non-operational column, preferably to maintain a constant pressure in the non-operational column.

The method can comprise switching the liquid chromatography system from the intermediate failover operation mode to the failover operation mode.

The method can comprise switching the liquid chromatography system from the second intermediate failover configuration to the first failover configuration. As described, the second intermediate failover configuration and the first failover configuration can be substantially the same, thus allowing for a seamless transition to the failover operation mode.

Operating the separation pump in the second failover configuration to supply a flow from the operational column to the detector can comprise starting the provision of a mobile phase at the first failover switching time. Thus, providing the mobile phase can be started after the system being in the first failover configuration in which the operational column can be washed and/or a new sample can be injected into the LC system.

In the second failover configuration, the method can comprise stopping the provision of the mobile phase from the operational column to the detector at a flow stopping time.

The flow stopping time can be before the second failover switching time. This can allow the mobile phase occupying the operational column, and further optionally the fluidic connections to the operational column to reach the detector and to thereby free the operational column and/or the fluidic connections to the operational column from the mobile phase.

A time difference between the second failover switching time and the flow stopping time can amount to between 0 minutes and 50 minutes, preferably between 1 minute and 25 minutes, more preferably between 2 minutes and 10 minutes.

A time difference between the second failover switching time and the flow stopping time can depend on a volume of the operational column, on a volume of fluidic connections connected to the operational column, and on a flow rate of the separation pump. This can allow for an optimum calculation of said time difference allowing for the mobile phase occupying the operational column, and further optionally the fluidic connections to the operational column to reach the detector.

The time difference between the second failover switching time and the flow stopping time can be determined by dividing a total volume of the operational column and of the fluidic connections connected to the operational column with the flow rate of the separation pump.

Operating the separation pump in the second failover configuration to supply a flow from the operational column to the detector can comprise providing a gradient.

Providing the gradient can be a two-part process comprising providing a first gradient and providing a second gradient.

The method can comprise deactivating the detector in the first failover configuration. That is, during the first failover configuration the detector can be maintained in a deactivated state. This can be advantageous as during this state the operational column may be washed and therefore there may be no sample to detect.

The method can comprise deactivating the detector at the second failover switching time. That is, the detector can be deactivating when switching the system from the second failover configuration to the first failover configuration.

The method can comprise activating the detector in the second failover configuration at a detector activation time.

The detector activation time can be after the first failover switching time. It is noted that in some embodiments, the separation pump can be configured to start providing a mobile phase at the first failover switching time. However, due to the volume of the operational column and/or due to the volume of fluidic connections connected to the operational column it may take some time for the mobile phase to reach the detector. Therefore, it can be more efficient to activate the detector after the first failover switching time. This can reduce or even eliminate a time period during which the detector is activated, but the mobile phase has not yet reached the detector.

A time difference between the first failover switching time and the detector activation time can amount to between 0 minutes and 50 minutes, preferably between 1 minute and 25 minutes, more preferably between 2 minutes and 10 minutes.

A time difference between the first failover switching time and the detector activation time can depend on a volume of the operational column, on a volume of fluidic connections connected to the operational column, and on a flow rate of the separation pump. This can optimize the time difference such that the detector can be activated just as the mobile phase reaches the detector.

The time difference between the first failover switching time and the detector activation time can be determined by dividing a total volume of the operational column and of the fluidic connections connected to the operational column with the flow rate of the separation pump.

The time difference between the first failover switching time and the detector activation time can be equal to the time difference between the second failover switching time and the flow stopping time.

The method can comprise controlling activation and/or deactivation of the detector using the controller. That is, activation and/or deactivation of the detector may be performed automatically via the controller, i.e., without the need of manual intervention.

The liquid chromatography system can comprise a pre-column switching valve, wherein the pre-column switching valve can comprise a plurality of ports and a plurality of connecting elements for interchangeably connecting the ports. One port of the pre-column switching valve can be fluidly connected to the separation pump. One port of the pre-column switching valve can be fluidly connected to one of the separation columns. One port of the pre-column switching valve can be fluidly connected to the other one of the separation columns. Therefore, the pre-column switching valve can be utilized to fluidly connect the separation pump with the separation columns and to switch the connections therebetween.

The pre-column switching valve may be upstream the separation columns.

The pre-column switching valve can be downstream the separation pump.

The pre-column switching valve can be downstream the second pump.

Switching the liquid chromatography system from the first failover configuration to the second failover configuration can be performed by switching the pre-column switching valve.

Switching the liquid chromatography system from the second failover configuration to the first failover configuration can be performed by switching the pre-column switching valve.

Switching the liquid chromatography system from the first intermediate failover configuration to the second intermediate failover configuration can be performed by switching the pre-column switching valve.

It will be understood that switching the pre-column switching valve may change the arrangement between the ports and the connecting elements of the pre-column switching valve, thereby establishing different fluid connections between the ports of the pre-column switching valve.

The pre-column switching valve can be controlled with a controller. That is, the pre-column switching valve can preferably be switched automatically. For example, the pre-column switching valve may comprise one or more actuators that can be controlled with the controller, wherein said one or more actuators may change the arrangement between the ports and the connecting elements of the pre-column switching valve.

The port of the pre-column switching valve that can be fluidly connected to the separation pump can be fluidly connected in the first failover configuration to the port of the pre-column switching valve that can be fluidly connected to the non-operational column and in the second failover to the port of the pre-column switching valve that can be fluidly connected to the operational column.

The port of the pre-column switching valve that can be fluidly connected to the separation pump can be fluidly connected in the first intermediate failover configuration to the port of the pre-column switching valve that can be fluidly connected to the operational column and in the second intermediate failover to the port of the pre-column switching valve that can be fluidly connected to the non-operational column.

One port of the pre-column switching valve can be fluidly connected to the second pump.

The port of the pre-column switching valve that can be fluidly connected to the second pump can be fluidly connected in the first failover configuration to the port of the pre-column switching valve that can be fluidly connected to the operational column and in the second failover to the port of the pre-column switching valve that can be fluidly connected to the non-operational column.

The port of the pre-column switching valve that can be fluidly connected to the second pump can be fluidly connected in the first failover intermediate configuration to the port of the pre-column switching valve that can be fluidly connected to the non-operational column and in the second intermediate failover to the port of the pre-column switching valve that can be fluidly connected to the operational column.

The liquid chromatography system can comprise a post-column switching valve, wherein the post-column switching valve can comprise a plurality of ports and a plurality of connecting elements for interchangeably connecting the ports. One port of the post-column switching valve can be fluidly connected to one of the separation columns. One port of the post-column switching valve can be fluidly connected to the other one of the separation columns. One port of the post-column switching valve can be fluidly connected to the detector. Therefore, the post-column switching valve can be utilized to fluidly connect the detector with the separation columns and to switch the connections therebetween.

The post-column switching valve may be downstream the separation columns.

The post-column switching valve may be upstream the detector.

In the failover operation mode, the port of the post-column switching valve that can be fluidly connected to the operational column can be fluidly connected to the port of the post-column switching valve that can be fluidly connected to the detector. Said connection may be maintained during the entire failover operation mode.

One port of the post-column switching valve can be fluidly connected to a waste.

In the failover operation mode, the port of the post-column switching valve that can be fluidly connected to the non-operational column can be fluidly connected to the port of the post-column switching valve that can be fluidly connected to the waste. Said connection may be maintained during the entire failover operation mode.

In the intermediate failover operation mode, the port of the post-column switching valve that can be fluidly connected to the non-operational column can be fluidly connected to the port of the post-column switching valve that can be fluidly connected to the waste.

In the intermediate failover operation mode, the port of the post-column switching valve that can be fluidly connected to the operational column can be fluidly connected to the port of the post-column switching valve that can be fluidly connected to the detector.

It will be understood that switching the post-column switching valve may change the arrangement between the ports and the connecting elements of the post-column switching valve, thereby establishing different fluid connections between the ports of the post-column switching valve.

The post-column switching valve can be controlled with a controller. That is, the post-column switching valve can preferably be switched automatically. For example, the post-column switching valve may comprise one or more actuators that can be controlled with the controller, wherein said one or more actuators may change the arrangement between the ports and the connecting elements of the post-column switching valve.

The liquid chromatography system can comprise an injection valve, wherein the injection valve can comprise a plurality of ports and a plurality of connecting elements for interchangeably connecting the ports. One port of the injection valve can be fluidly connected to an injection pump. One port of the injection valve can be fluidly connected to a port of the pre-column switching valve. In such embodiments, the method can comprise fluidly connecting the port of the injection valve, which can be fluidly connected to the injection pump, to the port of the injection valve, which can be fluidly connected the pre-column switching valve.

The injection pump can be the separation pump or the second pump, preferably the second pump.

That is the injection pump may not be a third pump, but instead may be either the separation pump or the second pump. Preferably, the second pump can be the injection pump. That is, the separation pump or the second pump, preferably the latter, and the injection pump may be one and the same.

The injection valve can further comprise another plurality of ports, and wherein the method can comprise fluidly connecting the other plurality of ports to a plurality of sample reservoirs containing a plurality of samples. That is, the LC system may be configured to obtain via the injection valve a plurality of samples provided in respective sample reservoirs.

The method can comprise the injection, via the injection valve, of a sample from a sample reservoir into the liquid chromatography system.

The method can comprise providing a flow of a sample from the injection valve towards the pre-column switching valve with the injection pump.

The method can comprise a sample switching process comprising switching, via the injection valve, from injecting a sample from a sample reservoir into the liquid chromatography system, to injecting another sample from another sample reservoir into the liquid chromatography system. This can allow the LC system to analyze a plurality of samples one after the other.

The sample switching process can be performed by switching the injection valve. Switching the injection switching valve may change the arrangement between the ports and the connecting elements of the injection valve, thereby establishing different fluid connections between the ports of the injection valve.

The injection valve can be controlled with a controller. That is, the injection valve can preferably be switched automatically. For example, the injection valve may comprise one or more actuators that can be controlled with the controller, wherein said one or more actuators may change the arrangement between the ports and the connecting elements of the injection valve.

The method can comprise performing the sample switching process while the liquid chromatography system can be in the first failover configuration. That is, the sample switching process can be performed while the operational column is connected to the second pump. This can be advantageous as the sample switching process and the preparation of the operational column for a new sample (e.g., washing of the operational column) can be performed simultaneously.

The sample switching process can start at or after a start of the first failover configuration.

The sample switching process for a subsequent cycle can start at or after the second failover switching time.

The method can comprise operating the liquid chromatography system in a normal operation mode prior to detecting the failover activation event. In the normal operation mode, the method may comprise utilizing all the separation columns, preferably in tandem, to perform liquid chromatography. By utilizing all the separation columns, the LC system may comprise a high throughput during the normal operation mode.

The method can comprise switching the liquid chromatography system from the normal operation mode to the intermediate failover operation mode upon detecting the failover activation event. The intermediate failover operation mode may allow for processes and/or cycles of the normal operation mode in progress during the failover activation event to be completed. This can be advantageous, as it can avoid sample loss, e.g., washing a sample away without analyzing it.

Switching the liquid chromatography system from the normal operation mode to the intermediate failover operation mode can comprise modifying the normal operation mode such that a sample switching process can be skipped. That is, a sample which would under the normal operation mode be injected to the LC system, is not injected during the intermediate failover operation mode. This can be advantageous as it can avoid losing said sample.

Switching the liquid chromatography system from the normal operation mode to the intermediate failover operation mode can comprise modifying the normal operation mode such that loading a sample into the non-operational column can be skipped. That is, a sample which would under the normal operation mode be loaded into the non-operational column, is not loaded during the intermediate failover operation mode. This can be advantageous as it can avoid losing said sample.

Switching the liquid chromatography system from the normal operation mode to the intermediate failover operation mode can comprise modifying the normal operation mode such that providing a flow from the non-operational column to the detector can be skipped.

Operating the liquid chromatography system in the normal operation mode can comprise operating the liquid chromatography system in a first steady state configuration.

The first steady state configuration may also be referred to as a first configuration.

In the first steady state configuration the first separation column can be fluidly connected to the separation pump and to the detector and the separation pump can be operated to supply a flow from the first separation column towards the detector.

In the first steady state configuration, the second separation column can be fluidly connected to the second pump and to a waste, and wherein the method can further comprise supplying, with the second pump, a flow from the second separation column towards the waste.

Operating the liquid chromatography system in the normal operation mode can comprise operating the liquid chromatography system in a second steady state configuration.

The second steady state configuration may also be referred to as a third configuration.

In the second steady state configuration the second separation column can be fluidly connected to the separation pump and to the detector, and the separation pump can be operated to supply a flow from the second separation column towards the detector.

In the second steady state configuration, the first separation column can be fluidly connected to the second pump and to a waste, and wherein the method can further comprise supplying, with the second pump, a flow from the first separation column towards the waste.

The method can comprise operating the liquid chromatography in a first intermediate configuration.

The first intermediate configuration may also be referred to as a second configuration.

In the first intermediate configuration, the first separation column can be fluidly connected to a second pump and to the detector, and the second pump can be operated to supply a flow from the first separation column towards the detector.

In the first intermediate configuration, the second separation column can be fluidly connected to the separation pump and to a waste, and the method can comprise supplying a flow, with the separation pump, from the second separation column towards the waste.

The method can comprise operating the liquid chromatography in a second intermediate configuration.

The second intermediate configuration may also be referred to as a fourth configuration.

In the second intermediate configuration, the second separation column can be fluidly connected to a second pump and to the detector, and the second pump can be operated to supply a flow from the second separation column towards the detector.

In the second intermediate configuration, the first separation column can be fluidly connected to the separation pump and to a waste, and the method can comprise supplying a flow, with the separation pump, from the first separation column towards the waste.

The method can comprise switching the liquid chromatography system from the first steady state configuration to the first intermediate configuration at a first switching time, preferably by switching the pre-column switching valve.

The method can comprise switching the liquid chromatography system from the first intermediate configuration to the second steady state configuration at a second switching time, preferably by switching the post-column switching valve.

The method can comprise switching the liquid chromatography system from the second steady state configuration to the second intermediate configuration at a third switching time, preferably by switching the pre-column switching valve.

The method can comprise switching the liquid chromatography system from the second intermediate configuration to the first first-state configuration at a fourth switching time, preferably by switching the post-column switching valve.

Said switching(s) can be performed with a controller. That is, during the normal operation mode the LC system may be switched between the different configurations automatically via the controller, i.e., without the need of manual intervention.

The normal operation mode can be a cyclic process. For each cycle the method can comprise performing the switches performed at the first, second, third and fourth switching time. Thus, at each cycle the LC system can be in each of the first to fourth configurations.

The method can comprise operating the liquid chromatography system in the first intermediate configuration for a first intermediate duration.

The first intermediate duration can amount to between 0 minutes and 50 minutes, preferably between 1 minute and 25 minutes, more preferably between 2 minutes and 10 minutes.

The first intermediate duration can depend on a volume of the second separation column, on a volume of fluidic connections connected to the second separation column, and on a flow rate of the separation pump.

The first intermediate duration can be determined by dividing a total volume of the second separation column and of the fluidic connections connected to the second separation column with the flow rate of the separation pump.

The method can comprise operating the liquid chromatography system in the second intermediate configuration for a second intermediate duration.

The second intermediate duration can amount to between 0 minutes and 50 minutes, preferably between 1 minute and 25 minutes, more preferably between 2 minutes and 10 minutes.

The second intermediate duration can depend on a volume of the first separation column, on a volume of fluidic connections connected to the first separation column, and on a flow rate of the separation pump. This can allow the mobile phase occupying the first separation column, and further optionally the fluidic connections to the first separation column to reach the detector and to thereby free the first separation column and/or the fluidic connections to the first separation column from the mobile phase.

The second intermediate duration can be determined by dividing a total volume of the first separation column and of the fluidic connections connected to the first separation column with the flow rate of the separation pump. This can allow for an optimum calculation of the second intermediate duration allowing for the mobile phase occupying the first separation column, and further optionally the fluidic connections to the first separation column to reach the detector.

The method can comprise starting a first sample switching process at or after the first switching time.

The method can comprise ending the first sample switching process before the third switching time.

The method can comprise starting a second sample switching process at or after the third switching time.

The method can comprise ending the second sample switching process before a subsequent switch from the first steady state configuration to the first intermediate configuration.

The method can comprise, starting, at the first switching time, provision of a first mobile phase, by the separation pump, from the second separation column towards the detector.

The method according to the preceding embodiment, stopping the provision of the first mobile phase, by the separation pump, after the second switching time and at or before the third switching time.

The method can comprise starting, at the second switching time, detection of the first mobile phase with the detector.

The method can comprise stopping detection of the first mobile phase with the detector after the third switching time and at or before the fourth switching time.

Starting provision of the first mobile phase can comprise providing a first gradient.

The method can comprise controlling the starting and stopping of the first mobile phase with a controller.

The method can comprise controlling the starting and stopping of detection of the first mobile phase with the controller.

The method can comprise starting, at the third switching time, the provision of a second mobile phase, by the separation pump, from the first separation column towards the detector.

The method can comprise stopping the provision of the second gradient, by the separation pump, after the fourth switching time and at or before a time of a subsequent switch from the second intermediate configuration to the first steady state configuration.

The method can comprise starting, at the fourth switching time, detection of the second mobile phase with the detector.

The method can comprise stopping detection of the second mobile phase with the detector after a subsequent switch from the first steady state configuration to the first intermediate configuration and at or before a time of a subsequent switch from the first intermediate configuration to the second steady state configuration.

Starting provision of the second mobile phase can comprise providing a second gradient.

The method can comprise controlling the starting and stopping of the second mobile phase with a controller.

The method can comprise controlling the starting and stopping of detection of the second mobile phase with the controller.

Each cycle of the normal operation mode can comprise providing the first mobile phase and the second mobile phase.

At the first switching time, a solvent composition delivered by the second pump can be substantially identical to a solvent composition delivered by the separation pump.

At the third switching time, a solvent composition delivered by the second pump can be substantially identical to a solvent composition delivered by the separation pump.

Operating the liquid chromatography system in a normal operation mode can comprise starting provision of a mobile phase into one of the columns, by the separation pump and starting, after a predetermined time delay from starting provision of said mobile phase, detection of said mobile phase with the detector.

The time delay can amount to between 0 minutes and 50 minutes, preferably between 1 minute and 25 minutes, more preferably between 2 minutes and 10 minutes.

The time delay can depend on a volume of the column in which said mobile phase is provided, on a volume of fluidic connections connected to said column, and on a flow rate of the separation pump.

The predetermined time delay can be determined by dividing a total volume of the said column and of the fluidic connections connected to said column with the flow rate of the separation pump.

In the normal operation mode, a flow from each of the separation columns towards the detector has a flow rate in the range of 0 to 10 mL/min, preferably 0 to 100 μL/min, such as 0.1 to 10 μL/min.

In the failover operation mode, a flow from the operational column towards the detector has a flow rate in the range of 0 to 10 mL/min, preferably 0 to 100 μL/min, such as 0.1 to 10 μL/min.

In the intermediate failover operation mode, a flow from the operational column towards the detector has a flow rate in the range of 0 to 10 mL/min, preferably 0 to 100 μL/min, such as 0.1 to 10 μL/min.

In the first steady state configuration and/or in the second-steady state operation, a pressure provided by the separation pump can be in the range of 100 bar to 2,000 bar, preferably 200 bar to 1,500 bar, such as 500 bar to 1,500 bar.

A pressure provided by the separation pump when connected to the operational column can be in the range of 100 bar to 2,000 bar, preferably 200 bar to 1,500 bar, such as 500 bar to 1,500 bar.

The method can comprise carrying out an analytical process with the liquid chromatography system and generating an analytical result. The method can further comprise determining at least one deviation between the analytical result and a reference result. In such embodiments, detecting the failover activation event can comprise detecting the at least one deviation exceeding a predefined deviation range. In other words, a compromised LC system, i.e., a system wherein one of the separation columns becomes non-operational, can produce unexpected analytical results. This rationale can thus be used to detect comprised LC systems by determining at least one deviation between the analytical result and the reference result and in particular, by detecting instances when the at least one deviation exceed a predefined deviation range. Said range can be configured such that the at least one deviation exceeding the range can indicate that one of the columns is non-operational.

The analytical process can be a liquid chromatography process.

The analytical process can be a gradient chromatography process and wherein performing the analytical process can comprise mixing at least a first solvent and a second solvent in mixing ratios that vary over time.

The analytical result can be a chromatogram and the reference result can be a reference chromatogram. Each chromatogram can comprise a signal strength as a function of time.

Determining at least one deviation between the analytical result and the reference result can comprise identifying signal peaks in the chromatogram and corresponding peaks in the reference chromatogram, determining time differences between the signal peaks in the chromatogram and the corresponding peaks in the reference chromatogram and identifying a time difference pattern between the signal peaks in the chromatogram and the corresponding peaks in the reference chromatogram.

Determining the at least one deviation between the analytical result and the reference result can be carried out by a controller.

In a second aspect, the present invention relates to a system for liquid chromatography. The system comprises a first separation column, a second separation column, a separation pump upstream the separation columns and a detector downstream the separation columns.

The system can comprise a second pump, upstream the separation columns.

The system can comprise a pre-column switching valve, wherein the pre-column switching valve can comprise a plurality of ports and a plurality of connecting elements for interchangeably connecting the ports. One port of the pre-column switching valve can be fluidly connected to the separation pump. One port of the pre-column switching valve can be fluidly connected to one of the separation columns. One port of the pre-column switching valve can be fluidly connected to the other one of the separation columns.

The pre-column switching valve can be upstream the separation columns.

The pre-column switching valve can be downstream the separation pump.

The pre-column switching valve can be downstream the second pump.

The system can comprise an injection valve, wherein the injection valve can comprise a plurality of ports and a plurality of connecting elements for interchangeably connecting the ports. One port of the injection valve can be fluidly connected to an injection pump, and one port of the injection valve can be fluidly connected to a port of the pre-column switching valve.

The system can comprise a post-column switching valve, wherein the post-column switching valve can comprise a plurality of ports and a plurality of connecting elements for interchangeably connecting the ports. One port of the post-column switching valve can be fluidly connected to one of the separation columns. One port of the post-column switching valve can be fluidly connected to the other one of the separation columns. One port of the post-column switching valve can be fluidly connected to the detector.

The post-column switching valve can be downstream the separation columns.

The post-column switching valve can be upstream the detector.

The system can comprise sample reservoirs, each containing a respective sample.

The system can be configured to be fluidly connected with sample reservoirs, each containing a respective sample. A fluid connection between the system and a sample reservoir may be established via a needle of the system configured to be received in the sample reservoir.

The system can comprise a waste.

The system can comprise a controller. The controller may comprise a processing unit which may be singular or plural, and may be, but not limited to, a CPU (central processing unit). GPU (graphical processing unit), DSP (digital signal processor). APU (accelerator processing unit). ASIC (application-specific integrated circuit), ASIP (application-specific instruction-set processor) or FPGA (field programable gate array).

The controller may comprise and/or may be operatively connected to a memory component. The memory component may be singular or plural, and may be, but is not limited to, a volatile or non-volatile memory, such as a random-access memory (RAM). Dynamic RAM (DRAM), Synchronous Dynamic RAM (SDRAM), static RAM (SRAM). Flash Memory, Magneto-resistive RAM (MRAM). Ferroelectric RAM (F-RAM), or Parameter RAM (P-RAM).

The controller can be configured to control the separation pump.

The controller can be configured to control the second pump.

The controller can be configured to control the pre-column switching valve.

The controller can be configured to control the injection valve.

The controller can be configured to control the post-column switching valve.

The system can be for high-performance liquid chromatography system.

The system can be configured to carry out the method according the first aspect of the present invention.

The controller can be configured to control system components to carry out the method according the first aspect of the present invention.

In a third aspect, the present invention relates to a use of the method according to the first aspect of the present invention to operate a liquid chromatography system according to the second aspect of the present invention.

In a fourth aspect, the present invention relates to a use of the liquid chromatography system according to the second aspect of the present invention for tandem liquid chromatography.

In a fifth aspect, the present invention relates to a use of the liquid chromatography system according to the second aspect of the present invention to carry out the method according to the first aspect of the present invention.

In the use according to any of the third to fifth aspect, a controller can be used to automatically execute a workflow according to any of the preceding method embodiments.

In a sixth aspect, the present invention relates to a computer program product comprising instructions which, when executed by a processor, cause the processor to control a system for liquid chromatography to carry out the method according to the first aspect of the present invention.

In a seventh aspect, the present invention relates to a computer-readable medium comprising instructions which, when executed by a processor, cause the processor to control a system for liquid chromatography to carry out the method according to the first aspect of the present invention.

In an eighth aspect, the present invention relates to a data carrying signal carrying the computer program product according to the sixth aspect of the present invention.

The present invention may thus:
provide seamless transition from normal operation mode to failover operation mode;
alleviate the need for sample injection list changes;
allow for similar operation as in “normal tandem direct injection” and therefore no compromises regarding analytical results;
increase robustness;
increase ease of use;
reduce unplanned downtime;
better utilize redundancy;
mitigate sample loss.

It will be understood that the application of the failover mode for tandem direct injection can be just one possible use case. In principle, the failover concept may be applied to any HPLC system where an intrinsic redundancy of columns exists, i.e., more than one (identical) column exists in the system that can be switched, preferably automatically, by means of a switching valve. A further example for such a system may be an HPLC system that can be configured for a tandem Trap & Elute (preconcentration workflows) or any HPLC system where multiple columns reside in a column compartment downstream of a column switching valve.

Below, reference will be made to method embodiments. These embodiments are abbreviated by the letter “M” followed by a number. Whenever reference is herein made to “method embodiments”, these embodiments are meant.

M1. A method in a liquid chromatography system comprising a first separation column, a second separation column, a separation pump upstream the separation columns and a detector downstream the separation columns, the method comprising:
detecting a failover activation event relating to one of the separation columns, said separation column being a non-operational column, while the other an operational column;
operating the liquid chromatography system in a failover operation mode, after detecting the failover activation event;
wherein operating the liquid chromatography system in the failover operation mode comprises:
allowing a fluid connection between the separation pump, the operational column and the detector and
preventing a fluid connection between the non-operational column and the detector.

Throughout the description, the first separation column and the second separation column are jointly referred to as separation columns.

M2. The method according to the preceding embodiment, wherein detecting the failover activation event comprises detecting a flow resistance of one of the separation columns exceeding a predefined resistance range.

M3. The method according to any of the preceding embodiments, wherein detecting the failover activation event comprises detecting a pressure value of one of the separation columns exceeding a predefined pressure range.

M4. The method according to any of the preceding embodiments, wherein the method comprises detecting the failover activation event while a flow is provided from said column towards the detector.

M5. The method according to any of the preceding embodiments, wherein operating the liquid chromatography system in the failover operation mode comprises loading samples into the operational column and preventing loading samples into the non-operational column.

M6. The method according to any of the preceding embodiments, wherein operating the liquid chromatography system in the failover operation mode comprises controlling a pressure in the non-operational column.

M7. The method according to any of the preceding embodiments, wherein controlling a pressure in the non-operational column comprises maintaining a constant pressure in the non-operational column.

M8. The method according to any of the preceding embodiments, wherein in the failover operation mode, the non-operational column is fluidly connected to a waste downstream the non-operational column and the operational column is fluidly connected to the detector.

M9. The method according to any of the preceding embodiments, wherein in the failover operation mode, fluid connections downstream the separation columns are maintained fixed

M10. The method according to any of the preceding embodiments, wherein the liquid chromatography system comprises a second pump upstream the separation columns.

Throughout the description the separation pump and the second pump are jointly referred to as pumps.

M11. The method according to the preceding embodiment, wherein operating the liquid chromatography system in the failover operation mode comprises cyclically switching each of the pumps between being fluidly connected to the non-operational column and to the operational column.

M12. The method according to any of the 2 preceding embodiments, wherein operating the liquid chromatography system in the failover operation mode comprises operating each of the pumps in a predetermined controlled mode when fluidly connected to the non-operational column.

M13. The method according to the preceding embodiment, wherein the predetermined controlled mode is a pressure-controlled mode, in which each pump is operated to control a pressure in the non-operational column, preferably to maintain a constant pressure in the non-operational column.

M14. The method according to any of the 4 preceding embodiments, wherein operating the liquid chromatography system in the failover operation mode comprises
operating the separation pump to supply a flow from the operational column to the detector and
operating the second pump to supply a flow from the operational column to a waste.

M15. The method according to any of the preceding embodiments, wherein operating the liquid chromatography system in the failover operation mode comprises operating the separation pump
in a predetermined controlled mode, when fluidly connected to the non-operational column and
to supply a flow from the operational column to the detector, when fluidly connected to the operational column.

M16. The method according to the preceding embodiment, wherein operating the separation pump in the predetermined controlled mode comprises operating the separation pump in a pressure-controlled mode, in which the separation pump is operated to control a pressure in the non-operational column, preferably to maintain a constant pressure in the non-operational column.

M17. The method according to any of the preceding embodiments and with the features of embodiment M10, wherein operating the liquid chromatography system in the failover operation mode comprises operating the second pump
in the predetermined controlled mode, when fluidly connected to the non-operational column and
to supply a flow from the operational column to a waste, when fluidly connected to the operational column.

M18. The method according to the preceding embodiment, wherein operating the second pump in the predetermined controlled mode comprises operating the second pump in a pressure-controlled mode, in which the second pump is operated to control a pressure in the non-operational column, preferably to maintain a constant pressure in the non-operational column.

M19. The method according to any of the preceding embodiments, wherein operating the liquid chromatography system in the failover operation mode comprises
operating the liquid chromatography system in a first failover configuration;
switching, at a first failover switching time, the liquid chromatography system from the first failover configuration to a second failover configuration;
operating the liquid chromatography system in the second failover configuration until a second failover switching time.

M20. The method according to the preceding embodiment, wherein the method comprises switching, at the second failover switching time, the liquid chromatography system from the second failover configuration to the first failover configuration.

M21. The method according to any of the 2 preceding embodiments, wherein operating the liquid chromatography system in the failover operation mode comprises cyclically switching between the first and the second failover configuration.

M22. The method according to any of the 3 preceding embodiments, wherein switching the liquid chromatography system between the first failover configuration and the second failover configuration is performed with a controller.

M23. The method according to any of the 4 preceding embodiments, wherein in the first failover configuration, the separation pump is fluidly connected to the non-operational column and is operated in a predetermined controlled mode.

M24. The method according to the preceding embodiment, wherein operating the separation pump in the predetermined controlled mode comprises operating the separation pump in a pressure-controlled mode, in which the separation pump is operated to control a pressure in the non-operational column, preferably to maintain a constant pressure in the non-operational column.

M25. The method according to any of the 6 preceding embodiments, wherein in the second failover configuration, the separation pump is fluidly connected to the operational column and is operated to supply a flow from the operational column to the detector.

M26. The method according to any of the 7 preceding embodiments and with the features of embodiment M10, wherein in the first failover configuration, the second pump is fluidly connected to the operational column and is operated to supply a flow from the operational column to a waste.

M27. The method according to any of the 8 preceding embodiments and with the features of embodiment M10, wherein in the second failover configuration, the second pump is fluidly connected to the non-operational column and is operated in a predetermined controlled mode.

M28. The method according to the preceding embodiment, wherein operating the second pump in the predetermined controlled mode comprises operating the second pump in a pressure-controlled mode, in which the second pump is operated to control a pressure in the non-operational column, preferably to maintain a constant pressure in the non-operational column.

M29. The method according to any of the preceding embodiments, wherein the method comprises operating the liquid chromatography system in an intermediate failover operation mode after detecting the failover activation.

M30. The method according to the preceding embodiment, wherein in the intermediate failover operation mode, the liquid chromatography system is operated such that loading of a sample into the non-operational column is prevented.

M31. The method according to any of the 2 preceding embodiments, wherein in the intermediate failover operation mode, the liquid chromatography system is operated such that injecting a sample from a reservoir into the liquid chromatography system is prevented.

M32. The method according to any of the 3 preceding embodiments, wherein in the intermediate failover operation mode, the liquid chromatography system is operated such that supplying a flow from the non-operational column to the detector is prevented.

M33. The method according to any of the 4 preceding embodiments, wherein operating the liquid chromatography system in the intermediate failover operation mode comprises
operating the liquid chromatography system in a first intermediate failover configuration;
switching, at a first intermediate failover switching time, the liquid chromatography system from the first failover configuration to a second intermediate failover configuration;
operating the liquid chromatography system in the second intermediate failover configuration until a second intermediate failover switching time.

34. The method according to the preceding embodiment, wherein the intermediate failover operation mode comprises operating the liquid chromatography system only once in each of the first and second intermediate failover configurations.

M35. The method according to any of the 2 preceding embodiments, wherein switching the liquid chromatography system from the first intermediate failover configuration to the second intermediate failover configuration is performed with a controller.

M36. The method according to any of the 3 preceding embodiments, wherein in the first intermediate failover configuration, the separation pump is fluidly connected to the operational column and is operated to supply a flow from the operational column to the detector.

M37. The method according to the preceding embodiment, wherein operating the separation pump in the first intermediate failover configuration to supply a flow from the operational column to the detector comprises providing a mobile phase, wherein preferably providing a mobile phase comprises providing a gradient.

M38. The method according to any of the 5 preceding embodiments and with the features of embodiment M10, wherein in the first intermediate failover configuration, the second pump is fluidly connected to the non-operational column and is operated to supply a flow from the non-operational column to a waste.

M39. The method according to any of the 6 preceding embodiments and with the features of embodiment M10, wherein in the second intermediate failover configuration, the second pump is fluidly connected to the operational column and preferably is operated to supply a flow from the operational column to the detector.

M40. The method according to the preceding embodiment, wherein operating the second pump in the second intermediate failover configuration to supply a flow from the operational column to the detector comprises providing a mobile phase, wherein preferably providing a mobile phase comprises providing a gradient.

M41. The method according to any of the 8 preceding embodiments, wherein in the second intermediate failover configuration, the separation pump is fluidly connected to the non-operational column and is preferably operated in a predetermined controlled mode.

M42. The method according to the preceding embodiment, wherein operating the separation pump in the predetermined controlled mode comprises operating the separation pump in a pressure-controlled mode, in which the separation pump is operated to control a pressure in the non-operational column, preferably to maintain a constant pressure in the non-operational column.

M43. The method according to any of the preceding embodiments and with the features of embodiment M29, wherein the method comprises switching the liquid chromatography system from the intermediate failover operation mode to the failover operation mode.

M44. The method according to any of the preceding embodiments and with the features of embodiment M19 and M33, wherein the method comprises switching the liquid chromatography system from the second intermediate failover configuration to the first failover configuration.

M45. The method according to any of the preceding embodiments and with the features of embodiment M25, wherein operating the separation pump in the second failover configuration to supply a flow from the operational column to the detector comprises starting the provision of a mobile phase at the first failover switching time.

M46. The method according to the preceding embodiment, wherein in the second failover configuration, the method comprises stopping the provision of the mobile phase at a flow stopping time.

M47. The method according to the preceding embodiment, wherein the flow stopping time is before the second failover switching time.

M48. The method according to the preceding embodiment, wherein a time difference between the second failover switching time and the flow stopping time amounts to between 0 minutes and 50 minutes, preferably between 1 minute and 25 minutes, more preferably between 2 minutes and 10 minutes.

M49. The method according to any of the 2 preceding embodiments, wherein a time difference between the second failover switching time and the flow stopping time depends on a volume of the operational column, on a volume of fluidic connections connected to the operational column, and on a flow rate of the separation pump.

M50. The method according to the preceding embodiment, wherein the time difference between the second failover switching time and the flow stopping time is determined by dividing a total volume of the operational column and of the fluidic connections connected to the operational column with the flow rate of the separation pump.

M51. The method according to any of the preceding embodiments and with the features of embodiment M25, wherein operating the separation pump in the second failover configuration to supply a flow from the operational column to the detector comprises providing a gradient.

M52. The method according to the preceding embodiment, wherein providing the gradient is a two-part process comprising providing a first gradient and providing a second gradient.

M53. The method according to any of the preceding embodiments and with the features of embodiment M19, wherein the method comprises deactivating the detector in the first failover configuration.

M54. The method according to the preceding embodiment, wherein the method comprises deactivating the detector at the second failover switching time.

M55. The method according to any of the preceding embodiments and with the features of embodiment M19, wherein the method comprises activating the detector in the second failover configuration at a detector activation time.

M56. The method according to the preceding embodiment, wherein the detector activation time is after the first failover switching time.

M57. The method according to the preceding embodiment, wherein a time difference between the first failover switching time and the detector activation time amounts to between 0 minutes and 50 minutes, preferably between 1 minute and 25 minutes, more preferably between 2 minutes and 10 minutes.

M58. The method according to any of the 2 preceding embodiments, wherein a time difference between the first failover switching time and the detector activation time depends on a volume of the operational column, on a volume of fluidic connections connected to the operational column, and on a flow rate of the separation pump.

M59. The method according to the preceding embodiment, wherein the time difference between the first failover switching time and the detector activation time is determined by dividing a total volume of the operational column and of the fluidic connections connected to the operational column with the flow rate of the separation pump.

M60. The method according to any of the 4 preceding embodiments and with the features of embodiment M47, wherein the time difference between the first failover switching time and the detector activation time is equal to the time difference between the second failover switching time and the flow stopping time.

M61. The method according to any of the preceding embodiments, wherein the method comprises controlling activation and/or deactivation of the detector using the controller.

M62. The method according to any of the preceding embodiments, wherein the liquid chromatography system comprises a pre-column switching valve, wherein the pre-column switching valve comprises a plurality of ports and a plurality of connecting elements for interchangeably connecting the ports, and wherein
one port of the pre-column switching valve is fluidly connected to the separation pump,
one port of the pre-column switching valve is fluidly connected to one of the separation columns, and
one port of the pre-column switching valve is fluidly connected to the other one of the separation columns.

M63. The method according to the preceding embodiment and with the features of embodiment M19, wherein switching the liquid chromatography system from the first failover configuration to the second failover configuration is performed by switching the pre-column switching valve.

M64. The method according to any of the 2 preceding embodiments and with the features of embodiment M20, wherein switching the liquid chromatography system from the second failover configuration to the first failover configuration is performed by switching the pre-column switching valve.

M65. The method according to any of the 3 preceding embodiments and with the features of embodiment M29, wherein switching the liquid chromatography system from the first intermediate failover configuration to the second intermediate failover configuration is performed by switching the pre-column switching valve.

M66. The method according to any of the 4 preceding embodiments, wherein the pre-column switching valve is controlled with a controller.

M67. The method according to any of the 5 preceding embodiments and with the features of embodiment M19, wherein the port of the pre-column switching valve that is fluidly connected to the separation pump is fluidly connected:
in the first failover configuration to the port of the pre-column switching valve that is fluidly connected to the non-operational column and
in the second failover to the port of the pre-column switching valve that is fluidly connected to the operational column.

M68. The method according to any of the 6 preceding embodiments and with the features of embodiment M29, wherein the port of the pre-column switching valve that is fluidly connected to the separation pump is fluidly connected:
in the first intermediate failover configuration to the port of the pre-column switching valve that is fluidly connected to the operational column and
in the second intermediate failover to the port of the pre-column switching valve that is fluidly connected to the non-operational column.

M69. The method according to any of the 7 preceding embodiments and with the features of embodiment M10, wherein one port of the pre-column switching valve is fluidly connected to the second pump.

M70. The method according to the preceding embodiment and with the features of embodiment M19, wherein the port of the pre-column switching valve that is fluidly connected to the second pump is fluidly connected:
in the first failover configuration to the port of the pre-column switching valve that is fluidly connected to the operational column and
in the second failover to the port of the pre-column switching valve that is fluidly connected to the non-operational column.

M71. The method according to any of the 2 preceding embodiments and with the features of embodiment M29, wherein the port of the pre-column switching valve that is fluidly connected to the second pump is fluidly connected:
in the first intermediate failover configuration to the port of the pre-column switching valve that is fluidly connected to the non-operational column and
in the second intermediate failover to the port of the pre-column switching valve that is fluidly connected to the operational column.

M72. The method according to any of the preceding embodiments, wherein the liquid chromatography system comprises a post-column switching valve, wherein the post-column switching valve comprises a plurality of ports and a plurality of connecting elements for interchangeably connecting the ports, and wherein
one port of the post-column switching valve is fluidly connected to one of the separation columns,
one port of the post-column switching valve is fluidly connected to the other one of the separation columns,
one port of the post-column switching valve is fluidly connected to the detector.

M73. The method according to the preceding embodiment, wherein in the failover operation mode, the port of the post-column switching valve that is fluidly connected to the operational column is fluidly connected to the port of the post-column switching valve that is fluidly connected to the detector.

M74. The method according to any of the 2 preceding embodiments, wherein one port of the post-column switching valve is fluidly connected to a waste.

M75. The method according to the preceding embodiment, wherein in the failover operation mode, the port of the post-column switching valve that is fluidly connected to the non-operational column is fluidly connected to the port of the post-column switching valve that is fluidly connected to the waste.

M76. The method according to any of the 2 preceding embodiments and with the features of embodiment M29, wherein in the intermediate failover operation mode, the port of the post-column switching valve that is fluidly connected to the non-operational column is fluidly connected to the port of the post-column switching valve that is fluidly connected to the waste.

M77. The method according to any of the 5 preceding embodiments, wherein in the intermediate failover operation mode, the port of the post-column switching valve that is fluidly connected to the operational column is fluidly connected to the port of the post-column switching valve that is fluidly connected to the detector.

M78. The method according to any of the 6 preceding embodiments, wherein the post-column switching valve is controlled with a controller.

M79. The method according to any of the preceding embodiments and with the features of embodiment M62, wherein the liquid chromatography system comprises an injection valve, wherein the injection valve comprises a plurality of ports and a plurality of connecting elements for interchangeably connecting the ports, and wherein
one port of the injection valve is fluidly connected to an injection pump,
one port of the injection valve is fluidly connected to a port of the pre-column switching valve,
wherein the method comprises
fluidly connecting the port of the injection valve, which is fluidly connected to the injection pump, to the port of the injection valve, which is fluidly connected the pre-column switching valve.

M80. The method according to the preceding embodiment and optionally with the features of embodiment M10, wherein the injection pump is the separation pump or the second pump, preferably the second pump.

That is the injection pump may not be a third pump, but instead may be either the separation pump or the second pump. Preferably, the second pump is the injection pump. That is, the separation pump or the second pump, preferably the latter, and the injection pump may be one and the same.

M81. The method according to any of the 2 preceding embodiments, wherein the injection valve further comprises another plurality of ports, and wherein the method comprises fluidly connecting the other plurality of ports to a plurality of sample reservoirs containing a plurality of samples.

M82. The method according to any of the 3 preceding embodiments, wherein the method comprises the injection, via the injection valve, of a sample from a sample reservoir into the liquid chromatography system.

M83. The method according to any of the 4 preceding embodiments, wherein the method comprises providing a flow of a sample from the injection valve towards the pre-column switching valve with the injection pump.

M84. The method according to any of the 5 preceding embodiments, wherein the method comprises a sample switching process comprising switching, via the injection valve,
from injecting a sample from a sample reservoir into the liquid chromatography system,
to injecting another sample from another sample reservoir into the liquid chromatography system.

M85. The method according to the preceding embodiment, wherein the sample switching process is performed by switching the injection valve.

M86. The method according to any of the 2 preceding embodiments, wherein the injection valve is controlled with a controller.

M87. The method according to any of the 3 preceding embodiments and with the features of embodiment M19, wherein the method comprises performing the sample switching process while the liquid chromatography system is in the first failover configuration.

M88. The method according to the preceding embodiment, wherein the sample switching process starts at or after a start of the first failover configuration.

M89. The method according to any of the 2 preceding embodiments, wherein the sample switching process for a subsequent cycle starts at or after the second failover switching time.

M90. The method according to any of the preceding embodiments, wherein the method comprises operating the liquid chromatography system in a normal operation mode prior to detecting the failover activation event.

M91. The method according to the preceding embodiment and with the features of embodiment M29, wherein the method comprises switching the liquid chromatography system from the normal operation mode to the intermediate failover operation mode upon detecting the failover activation event.

M92. The method according to the preceding embodiment and with the features of embodiment M84, wherein switching the liquid chromatography system from the normal operation mode to the intermediate failover operation mode comprises modifying the normal operation mode such that a sample switching process is skipped.

M93. The method according to any of the 2 preceding embodiments, wherein switching the liquid chromatography system from the normal operation mode to the intermediate failover operation mode comprises modifying the normal operation mode such that loading a sample into the non-operational column is skipped.

M94. The method according to any of the 3 preceding embodiments, wherein switching the liquid chromatography system from the normal operation mode to the intermediate failover operation mode comprises modifying the normal operation mode such that providing a flow from the non-operational column to the detector is skipped.

M95. The method according to any of the preceding embodiments and with the features of embodiment M90, wherein operating the liquid chromatography system in the normal operation mode comprises operating the liquid chromatography system in a first steady state configuration (I).

The first steady state configuration may also be referred to as a first configuration.

M96. The method according to the preceding embodiment, wherein in the first steady state configuration (I) the first separation column is fluidly connected to the separation pump and to the detector and the separation pump is operated to supply a flow from the first separation column towards the detector.

M97. The method according to any of the 2 preceding embodiments and with the features of embodiment M10, wherein in the first steady state configuration (I), the second separation column is fluidly connected to the second pump and to a waste, and wherein the method further comprises supplying, with the second pump, a flow from the second separation column towards the waste.

M98. The method according to any of the preceding embodiments and with the features of embodiment M90, wherein operating the liquid chromatography system in the normal operation mode comprises operating the liquid chromatography system in a second steady state configuration (III).

The second steady state configuration may also be referred to as a third configuration.

M99. The method according to the preceding embodiment, wherein in the second steady state configuration (III) the second separation column is fluidly connected to the separation pump and to the detector, and the separation pump is operated to supply a flow from the second separation column towards the detector.

M100. The method according to any of the 2 preceding embodiments and with the features of embodiment M10, wherein in the second steady state configuration (III), the first separation column is fluidly connected to the second pump and to a waste, and wherein the method further comprises supplying, with the second pump, a flow from the first separation column towards the waste.

M101. The method according to any of the preceding embodiments and with the features of embodiment M90, wherein operating the liquid chromatography system in the normal operation mode comprises operating comprises operating the liquid chromatography system in a first intermediate configuration (II).

M102. The method according to the preceding embodiment, wherein in the first intermediate configuration (II), the first separation column is fluidly connected to a second pump and to the detector, and the second pump is operated to supply a flow from the first separation column towards the detector.

The first intermediate configuration may also be referred to as a second configuration.

M103. The method according to any of the 2 preceding embodiments, wherein in the first intermediate configuration (II), the second separation column is fluidly connected to the separation pump and to a waste, and the method comprises supplying a flow, with the separation pump, from the second separation column towards the waste.

M104. The method according to any of the preceding embodiments and with the features of embodiment M90, wherein operating the liquid chromatography system in the normal operation mode comprises operating comprises operating the liquid chromatography in a second intermediate configuration (IV).

The second intermediate configuration may also be referred to as a fourth configuration.

M105. The method according to the preceding embodiment, wherein in the second intermediate configuration (IV), the second separation column is fluidly connected to a second pump and to the detector, and the second pump is operated to supply a flow from the second separation column towards the detector.

M106. The method according to the preceding embodiment, wherein in the second intermediate configuration (IV), the first separation column is fluidly connected to the separation pump and to a waste, and the method comprises supplying a flow, with the separation pump, from the first separation column towards the waste.

M107. The method according to any of the preceding embodiments and with the features of embodiments M95 and M101 and optionally with the features of embodiment M62, wherein the method comprises switching the liquid chromatography system from the first steady state configuration (I) to the first intermediate configuration (II) at a first switching time, preferably by switching the pre-column switching valve.

M108. The method according to any of the preceding embodiments and with the features of embodiments M98 and M101 and optionally with the features of embodiment M72, wherein the method comprises switching the liquid chromatography system from the first intermediate configuration (II) to the second steady state configuration (III) at a second switching time, preferably by switching the post-column switching valve.

M109. The method according to any of the preceding embodiments and with the features of embodiments M98 and M104 and optionally with the features of embodiment M62, wherein the method comprises switching the liquid chromatography system from the second steady state configuration (III) to the second intermediate configuration (IV) at a third switching time, preferably by switching the pre-column switching valve.

M110. The method according to any of the preceding embodiments and with the features of embodiments M95 and M104 and optionally with the features of embodiment M72, wherein the method comprises switching the liquid chromatography system from the second intermediate configuration (IV) to the first first-state configuration (I) at a fourth switching time, preferably by switching the post-column switching valve.

M111. The method according to any of the 4 preceding embodiments, wherein said switching(s) are performed with a controller.

M112. The method according to any of the preceding embodiments and with the features of embodiment M90, wherein the normal operation mode is a cyclic process.

M113. The method according to the preceding embodiment and with the features of embodiments M107 to M110, wherein for each cycle the method comprises performing the switches performed at the first, second, third and fourth switching time.

M114. The method according to any of the preceding embodiments and with the features of embodiment M101, wherein the method comprises operating the liquid chromatography system in the first intermediate configuration (II) for a first intermediate duration.

M115. The method according to the preceding embodiment, wherein the first intermediate duration amounts to between 0 minutes and 50 minutes, preferably between 1 minute and 25 minutes, more preferably between 2 minutes and 10 minutes.

M116. The method according to any of the 2 preceding embodiments, wherein the first intermediate duration depends on a volume of the second separation column, on a volume of fluidic connections connected to the second separation column, and on a flow rate of the separation pump.

M117. The method according to the preceding embodiment, wherein the first intermediate duration is determined by dividing a total volume of the second separation column and of the fluidic connections connected to the second separation column with the flow rate of the separation pump.

M118. The method according to any of the preceding embodiments and with the features of embodiment M104, wherein the method comprises operating the liquid chromatography system in the second intermediate configuration (II) for a second intermediate duration.

M119. The method according to the preceding embodiment, wherein the second intermediate duration amounts to between 0 minutes and 50 minutes, preferably between 1 minute and 25 minutes, more preferably between 2 minutes and 10 minutes.

M120. The method according to any of the 2 preceding embodiments, wherein the second intermediate duration depends on a volume of the first separation column, on a volume of fluidic connections connected to the first separation column, and on a flow rate of the separation pump.

M121. The method according to the preceding embodiment, wherein the second intermediate duration is determined by dividing a total volume of the first separation column and of the fluidic connections connected to the first separation column with the flow rate of the separation pump.

M122. The method according to any of the preceding embodiments and with the features of embodiment M84 and M107, wherein the method comprises starting a first sample switching process at or after the first switching time.

M123. The method according to the preceding embodiment and with the features of embodiment M109, wherein the method comprises ending the first sample switching process before the third switching time.

M124. The method according to any of the preceding embodiments and with the features of embodiment M84 and M109, wherein the method comprises starting a second sample switching process at or after the third switching time.

M125. The method according to the preceding embodiment and with the features of embodiment M107, wherein the method comprises ending the second sample switching process before a subsequent switch from the first steady state configuration to the first intermediate configuration.

M126. The method according to any of the preceding embodiments and with the features of embodiments M107 to M110, wherein the method comprises, starting, at the first switching time, provision of a first mobile phase, by the separation pump, from the second separation column towards the detector.

M127. The method according to the preceding embodiment, stopping the provision of the first mobile phase, by the separation pump, after the second switching time and at or before the third switching time.

M128. The method according to any of the 2 preceding embodiments, wherein the method comprises starting, at the second switching time, detection of the first mobile phase with the detector.

M129. The method according to any of the 3 preceding embodiments, wherein the method comprises stopping detection of the first mobile phase with the detector after the third switching time and at or before the fourth switching time.

M130. The method according to any of the 4 preceding embodiments, wherein starting provision of the first mobile phase comprises providing a first gradient.

M131. The method according to any of the 5 preceding embodiments, wherein the method comprises controlling the starting and stopping of the first mobile phase with a controller.

M132. The method according to any of the 6 preceding embodiments, wherein the method comprises controlling the starting and stopping of detection of the first mobile phase with the controller.

M133. The method according to any of the preceding embodiments and with the features of embodiments M107 to M110, wherein the method comprises starting, at the third switching time, the provision of a second mobile phase, by the separation pump, from the first separation column towards the detector.

M134. The method according to the preceding embodiment, wherein the method comprises stopping the provision of the second gradient, by the separation pump, after the fourth switching time and at or before a time of a subsequent switch from the second intermediate configuration to the first steady state configuration.

M135. The method according to any of the 2 preceding embodiments, wherein the method comprises starting, at the fourth switching time, detection of the second mobile phase with the detector.

M136. The method according to any of the 3 preceding embodiments, wherein the method comprises stopping detection of the second mobile phase with the detector after a subsequent switch from the first steady state configuration to the first intermediate configuration and at or before a time of a subsequent switch from the first intermediate configuration to the second steady state configuration.

M137. The method according to any of the 4 preceding embodiments, wherein starting provision of the second mobile phase comprises providing a second gradient.

M138. The method according to any of the 5 preceding embodiments, wherein the method comprises controlling the starting and stopping of the second mobile phase with a controller.

M139. The method according to any of the 6 preceding embodiments, wherein the method comprises controlling the starting and stopping of detection of the second mobile phase with the controller.

M140. The method according to any of the preceding embodiments and with the features of embodiments M112, M126 and M133, wherein each cycle of the normal operation mode comprises providing the first mobile phase and the second mobile phase.

M141. The method according to any of the preceding embodiments with the features of embodiment M107, wherein at the first switching time, a solvent composition delivered by the second pump is substantially identical to a solvent composition delivered by the separation pump.

M142. The method according to any of the preceding embodiments with the features of embodiment M109, wherein at the third switching time, a solvent composition delivered by the second pump is substantially identical to a solvent composition delivered by the separation pump.

M143. The method according to any of the preceding embodiments and with the features of embodiment M90, wherein operating the liquid chromatography system in a normal operation mode comprises
starting provision of a mobile phase into one of the columns, by the separation pump,
starting, after a predetermined time delay from starting provision of said mobile phase, detection of said mobile phase with the detector.

M144. The method according to the preceding embodiment, wherein the predetermined time delay amounts to between 0 minutes and 50 minutes, preferably between 1 minute and 25 minutes, more preferably between 2 minutes and 10 minutes.

M145. The method according to any of the 2 preceding embodiments, wherein the predetermined time delay depends on a volume of the column in which said mobile phase is provided, on a volume of fluidic connections connected to said column, and on a flow rate of the separation pump.

M146. The method according to the preceding embodiment, wherein the predetermined time delay is determined by dividing a total volume of the said column and of the fluidic connections connected to said column with the flow rate of the separation pump.

M147. The method according to any of the preceding embodiments and with the features of embodiment M90, wherein in the normal operation mode, a flow from each of the separation columns towards the detector has a flow rate in the range of 0 to 10 mL/min, preferably 0 to 100 μL/min, such as 0.1 to 10 μL/min.

M148. The method according to any of the preceding embodiments, wherein in the failover operation mode, a flow from the operational column towards the detector has a flow rate in the range of 0 to 10 mL/min, preferably 0 to 100 μL/min, such as 0.1 to 10 μL/min.

M149. The method according to any of the preceding embodiments and with the features of embodiment M29, wherein in the intermediate failover operation mode, a flow from the operational column towards the detector has a flow rate in the range of 0 to 10 mL/min, preferably 0 to 100 μL/min, such as 0.1 to 10 μL/min.

M150. The method according to any of the preceding embodiments and with the features of embodiment M95 and/or M98, wherein in the first steady state configuration (I) and/or in the second-steady state operation, a pressure provided by the separation pump is in the range of 100 bar to 2,000 bar, preferably 200 bar to 1,500 bar, such as 500 bar to 1,500 bar.

M151. The method according to any of the preceding embodiments, wherein a pressure provided by the separation pump when connected to the operational column is in the range of 100 bar to 2,000 bar, preferably 200 bar to 1,500 bar, such as 500 bar to 1,500 bar.

M152. The method according to any of the preceding embodiments, wherein the method comprises
carrying out an analytical process with the liquid chromatography system and generating an analytical result;
determining at least one deviation between the analytical result and a reference result;
and wherein detecting the failover activation event comprises detecting the at least one deviation exceeding a predefined deviation range.

M153. The method according to the preceding embodiment, wherein the analytical process is a liquid chromatography process.

M154. The method according to any of the 2 preceding embodiments, wherein the analytical process is a gradient chromatography process and wherein performing the analytical process comprises mixing at least a first solvent and a second solvent in mixing ratios that vary over time.

M155. The method according to any of the 3 preceding embodiments, wherein the analytical result is a chromatogram and the reference result is a reference chromatogram, and wherein each chromatogram comprises a signal strength as a function of time.

M156. The method according to the preceding embodiment, wherein determining at least one deviation between the analytical result and the reference result comprises:
identifying signal peaks in the chromatogram and corresponding peaks in the reference chromatogram;
determining time differences between the signal peaks in the chromatogram and the corresponding peaks in the reference chromatogram; and
identifying a time difference pattern between the signal peaks in the chromatogram and the corresponding peaks in the reference chromatogram.

M157. The method according to any of the 5 preceding embodiments, wherein determining the at least one deviation between the analytical result and the reference result is carried out by a controller.

Below, reference will be made to system embodiments. These embodiments are abbreviated by the letter “S” followed by a number. Whenever reference is herein made to “system embodiments”, these embodiments are meant.

S1. A system for liquid chromatography, the system comprising:
a first separation column,
a second separation column,
a separation pump upstream the separation columns and
a detector downstream the separation columns.

S2. The system according to the preceding embodiment, wherein the system comprises a second pump, upstream the separation columns.

S3. The system according to any of the 2 preceding embodiments, wherein the system comprises a pre-column switching valve, wherein the pre-column switching valve comprises a plurality of ports and a plurality of connecting elements for interchangeably connecting the ports, and wherein
one port of the pre-column switching valve is fluidly connected to the separation pump,
one port of the pre-column switching valve is fluidly connected to one of the separation columns, and
one port of the pre-column switching valve is fluidly connected to the other one of the separation columns.

S4. The system according to the preceding embodiment, wherein the system comprises an injection valve, wherein the injection valve comprises a plurality of ports and a plurality of connecting elements for interchangeably connecting the ports, and wherein
one port of the injection valve is fluidly connected to an injection pump, and
one port of the injection valve is fluidly connected to a port of the pre-column switching valve.

S5. The system according to any of the 4 preceding embodiments, wherein the system comprises a post-column switching valve, wherein the post-column switching valve comprises a plurality of ports and a plurality of connecting elements for interchangeably connecting the ports, and wherein
one port of the post-column switching valve is fluidly connected to one of the separation columns,
one port of the post-column switching valve is fluidly connected to the other one of the separation columns,
one port of the post-column switching valve is fluidly connected to the detector.

S5. The system according to any of the 5 preceding embodiments, wherein the system comprises sample reservoirs, each containing a respective sample.

S6. The system according to any of the 6 preceding embodiments, wherein the system comprises a waste.

S7. The system according to any of the 7 preceding embodiments, wherein the system comprises a controller.

S8. The system according to the preceding embodiment, wherein the controller is configured to control the separation pump.

S9. The system according to any of the 2 preceding embodiments and with the features of embodiment S2, wherein the controller is configured to control the second pump.

S10. The system according to any of the 3 preceding embodiments and with the features of embodiment S3, wherein the controller is configured to control the pre-column switching valve.

S11. The system according to any of the 4 preceding embodiments and with the features of embodiment S4, wherein the controller is configured to control the injection valve.

S12. The system according to any of the 5 preceding embodiments and with the features of embodiment S5, wherein the controller is configured to control the post-column switching valve.

S13. The system according to any of the preceding system embodiments, wherein the system is for high-performance liquid chromatography system.

S14. The system according to any of the preceding system embodiments, wherein the system is configured to carry out the method according to any of the preceding method embodiments.

S15. The system according to any of the preceding system embodiments and with the features of embodiment S7, wherein the controller is configured to control system components to carry out the method according to any of the preceding method embodiments.

Below, reference will be made to use embodiments. These embodiments are abbreviated by the letter “U” followed by a number. Whenever reference is herein made to “use embodiments”, these embodiments are meant.

U1. Use of the method according to any of the preceding method embodiments to operate a liquid chromatography system according to any of the preceding system embodiments.

U2. Use of the liquid chromatography system according to any of the preceding system embodiments for tandem liquid chromatography.

U3. Use of the liquid chromatography system according to any of the preceding system embodiments to carry out the method as recited in any of the preceding method embodiments.

U4. The use according to any of the preceding use embodiments, wherein a controller is used to automatically execute a workflow according to any of the preceding method embodiments.

Below, reference will be made to further embodiments. These embodiments are abbreviated by the letter “C” followed by a number. Whenever reference is herein made to “computer embodiments”, these embodiments are meant.

C1. A computer program product comprising instructions which, when executed by a processor, cause the processor to control a system for liquid chromatography to carry out the method according to any of the preceding method embodiments.

C2. A computer-readable medium comprising instructions which, when executed by a processor, cause the processor to control a system for liquid chromatography to carry out the method according to any of the preceding method embodiments.

C3. A data carrying signal carrying the computer program product of embodiment C1.

### BRIEF DESCRIPTION OF THE FIGURES

FIG. 1 illustrates exemplary chromatograms of a liquid chromatography system for different values of the time difference between the start of gradient delivery and the start of detection in the liquid chromatography system.

FIG. 2 depicts a liquid chromatography system in a first configuration of a normal operation mode, which may be referred to as “first steady state configuration”;

FIG. 3 depicts the system of FIG. 2 in a second configuration of the normal operation mode, which may be referred to as “first intermediate state configuration”;

FIG. 4 depicts the system of FIG. 2 in a third configuration of the normal operation mode, which may be referred to as “second steady state configuration”;

FIG. 5 depicts the system of FIG. 2 in a fourth configuration of the normal operation mode, which may be referred to as “second intermediate state configuration”;

FIG. 6 depicts an exemplary visualization of a workflow of a tandem liquid chromatography system in the normal operation mode with an optimized acquisition time window based on four configurations of the tandem liquid chromatography system;

FIG. 7 depicts another exemplary visualization of a workflow of a tandem liquid chromatography system in the normal operation mode with an optimized acquisition time window based on four configurations of the tandem liquid chromatography system;

FIG. 8 depicts on the workflow of FIG. 7, detection of a failover activation event;

FIG. 9 depicts skipped processes, during an intermediate failover operation mode, upon detecting a failover activation event;

FIG. 10 depicts an exemplary visualization of a workflow of a tandem liquid chromatography system in an intermediate failover activation mode;

FIG. 11 depicts an exemplary visualization of a workflow of a tandem liquid chromatography system in a failover activation mode.

### DETAILED DESCRIPTION OF THE FIGURES

It is noted that not all the drawings carry all reference signs. Instead, in some of the drawings, some of the reference signs have been omitted for sake of brevity and simplicity of illustration.

Hereafter, exemplary embodiments of the present invention will be described in detail, referring to the accompanying figures.

While in the following preferred embodiments of the present invention will be described, the person skilled in the art will understand that the preferred embodiments are provided for illustrative purposes only and to render the disclosure of the present invention complete, and should by no means be construed to limit the scope of the present invention, which is defined by the claims.

From a very general viewpoint, embodiments of the present invention relate to executing a workflow in tandem a liquid chromatography (LC) system. Embodiments relate to executing a workflow in a tandem liquid chromatography system, characterized by the utilization of two pumps and two separation columns.

In order to perform LC, in general, a sample is subjected to flow, by means of the action of a pump, through a separation column and towards a detector. The pump that is utilized in a liquid chromatography system may deliver a gradient into the separation column. That it, the composition of the mobile phase over time may be changed using the separation pump. The mobile phase, moreover, may traverse the separation column in a given amount of time. Such amount of time may in turn depend on the volume of the separation column, as well as on the fluidic connection fluidly connecting the separation column to the pump and the separation column to the detector. It may further depend on the flow rate of the pump. In other words, the gradient delivery at the separation pump at a given point in time may be different from the gradient delivery at the detector at the same given point. For example, right when the gradient starts being delivered by the pump, the gradient delivery at the pump is equal to the starting gradient delivery, while the gradient delivery at the detector will be equal to the starting gradient delivery at a later time.

In many prior art LC systems, the detector is configured to start the detection window as the pump starts delivering the gradient into the separation column. Such a workflow, however, hinders an optimized utilization of the detection window, since the detector is actively used beginning from when the pump starts delivering the gradient. In other words, the detector is actively used beginning from when the gradient delivery at the separation pump is the starting gradient and not when the gradient delivery at the detector is the starting gradient.

The present invention relates, at least in part, to a workflow, wherein the time difference between the start of gradient delivery and the start of detection is substantially different from zero, and may be optimized.

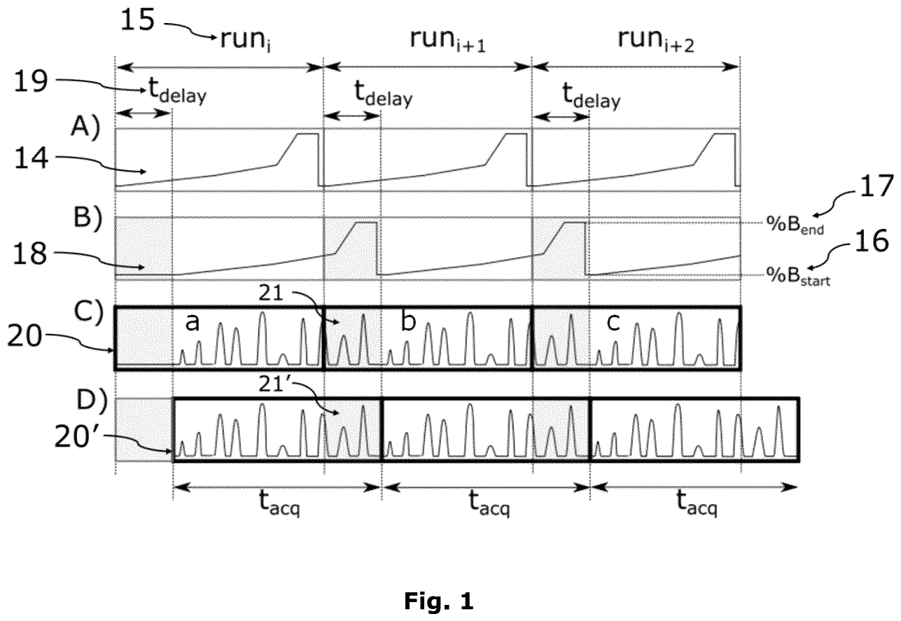

FIG. 1 illustrates exemplary chromatograms of a liquid chromatography system for different values of the time difference between the start of the gradient delivery and the start of the detection in the liquid chromatography system. Put differently, the effect the different values of said time difference is illustrated.

FIG. 1 A) shows an exemplary periodic time variation of the gradient delivery at the pump 14. Generally, a pump may deliver a gradient in a liquid chromatography procedure. That is, the solvent composition may change over time. For example, different solvents A and B may be mixed at different ratios. FIG. 1 A) (as FIG. 1 B)) depicts the volume % of solvent B in the solvent mixture over time. As depicted in FIG. 1 A), the amount of solvent B increases monotonously with different rates, is then held constant and is then decreased again during run I (see item 15), but it will be understood that this is merely exemplary and that other solvent compositions over time may be used. The subsequent runs i+1 and i+2 have a corresponding solvent composition delivered over time. The start of the gradient delivery at the pump 14 may coincide, in this exemplary embodiment, with the start of the sample run 15. The gradient delivery at the pump 14 at the start of the sample run 15 may substantially coincide with the starting gradient delivery 16. Analogously, the gradient delivery at the pump 14 at the end of the sample run 15 may substantially coincide with the ending gradient delivery 17. The sample run 15 may be temporally followed by subsequent sample runs.

Generally, it should be understood that FIG. 1 A) depicts the solvent composition at the pump, which may also be referred to as chromatographic pump or separation pump. Furthermore, it will be understood that the solvent composition at a detector downstream of the pump will be different to the solvent composition at the pump. In particular, there typically is a time lag or time delay (t_{delay}) between the two. Consider, for example, that the pump delivers with a flow rate of 10 μl/min and further consider that the fluidic path between the pump (e.g., connecting tubes, column, valves) have a total inner volume of 20 μl. In this example, it would take any change of solvent composition at the pump 2 min to arrive at the detector.

This is visible in FIG. 1 B), which depicts the solvent composition over time at the detector. In simple terms, this solvent composition corresponds to the solvent composition at the detector, but there is a time delay t_{delay} between the two. In other words, FIG. 1 B) shows an exemplary periodic time variation of the gradient delivery at the detector 18. It will be understood that the time difference t_{delay} 19 between the time at which the detector starts detecting and the time at which the gradient delivery starts at the pump 14 is usually different from zero.

FIG. 1 C) depicts exemplary chromatograms when not accounting for the time delay t_{delay}, i.e., in case that acquisition time windows 20 were chosen to coincide with the gradients runs (see 15) as delivered by the gradient pump. In this example, there are three acquisition time windows 20 a, 20 b, and 20 c, which coincide with the gradient delivery runs i, i+1, and i+2 at the pump. However, due to the time delay t_{delay}, the acquisition time windows are not ideal. In particular, there is a portion at the beginning of the first acquisition time window 20 a, where the gradient as delivered be the pump has not yet reached the detector. Furthermore, there is a portion 21 at the beginning of the second acquisition time window 20 b, where the gradient (and thus also sample) from the run i still arrives at the detector. That is, this portion 21 actually corresponds to the run i, but is (in the example discussed with reference to FIG. 1 C)) part of the data acquisition time window 20 a. It will be understood that similar considerations also apply to the data acquisition time window 20 c in FIG. 1 C).

FIG. 1 D) depicts exemplary chromatograms when the data acquisition time windows 20′ account for the time delay t_{delay}. It will be appreciated that the data acquisition time windows 20′ are shifted in the time domain with respect to the gradient runs 15 at the pump. Thus, the portion 21′ is correctly assigned to the first run. Furthermore, with regard to FIGS. 1 B) and 1 D), it will be appreciated that the data acquisition time windows correspond to the gradient as delivered at the detector.

Generally, in embodiments of the present invention, data acquisition time windows at the detector may be shifted with respect to analytical runs (or more specifically gradient runs) as delivered by the pump. This shift accounts for the time delay t_{delay}, i.e., the time it takes for the solvent to travel from the pump to the detector. It will be appreciated that better and more reproducible chromatograms are typically generated when taking the time delay into consideration by shifting the data acquisition time windows as described.

In tandem LC applications the workflows may be typically highly optimized for high throughput to obtain one chromatogram right after another. Therefore, the size/duration of the elution window may be consuming a significant portion of the duration of the gradient. Under these conditions, it may occur that the chromatogram may lack fractions of the compounds of interest. This is, for instance, illustrated in FIG. 1C. Additionally, it may occur that the resulting chromatogram is composed of compounds eluted partly from one separation column and partly from the other, which may not be intended as the chromatogram would not be strictly associated with a single sample run and even an individual sample. This is, for instance, illustrated in FIG. 1C. Hence, it may be advantageous to optimize t_{delay}.

It will be understood that embodiments of the herein presented approach allow to optimize the position of the elution window in the temporal domain, i.e., the period when compounds of interest are eluted from the separation column to achieve high sample throughput and uncompromised chromatographic performance. This may be realized by adjusting the start of the detector data acquisition relative to the start of the gradient as is illustrated in FIG. 1.

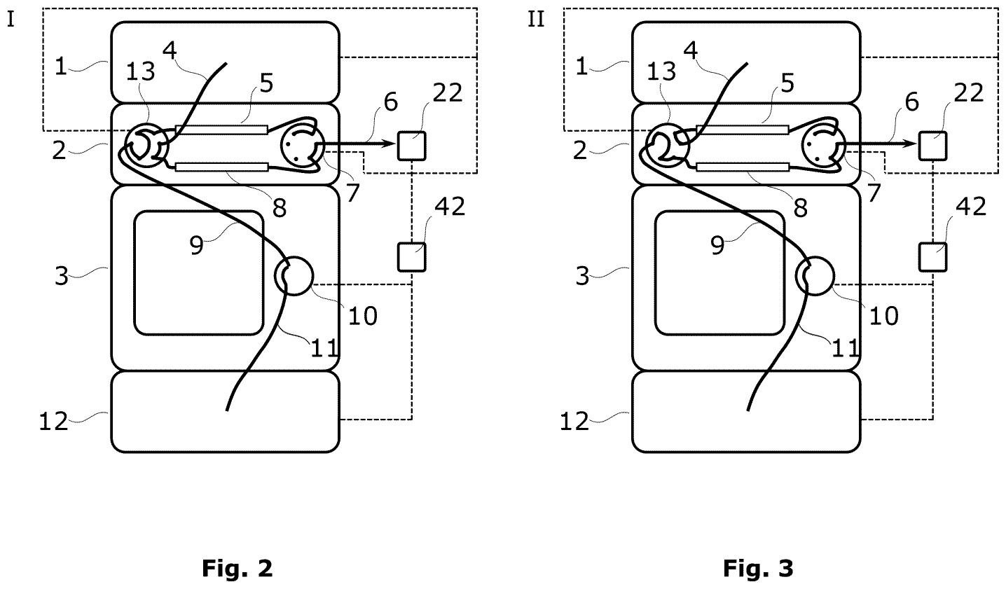

FIG. 2 depicts, as an example, a liquid chromatography system according to an embodiment of the present invention in a first configuration I of a normal operation mode. Said configuration may also be referred to as a first steady state configuration.

Embodiments of the present invention may be directed to utilizing a tandem liquid chromatography system, wherein two separation columns and two pumps are used. The liquid chromatography system, as illustrated in FIG. 2, may comprise a first separation column 8, a second separation column 5, a separation pump 1, a reconditioning pump 12 and a detector 22. The first separation column 8 and the second separation column 5 may be hosted in a column compartment 2. The system may comprise an autosampler 3, which may comprise an injection valve 10. The liquid chromatography system may further comprise a pre-column switching vale 13 and a post-column switching valve 7. The pre-column switching vale 13 and the post-column switching valve 7 may be hosted in the column compartment 2. The liquid chromatography system may comprise a waste (not depicted).

The reconditioning pump 12 may be interchangeably be referred to as a second pump 12.

Each of the injection valve 10, the pre-column switching valve 13 and the post-column switching valve 7 may comprise a stator, a rotor and a rotatable drive, respectively. Each stator may comprise a multitude of ports to which different elements in the liquid chromatography system may be fluidly connected to. Each rotor may comprise connecting elements, for example grooves, that may fluidly connect different ports of the stator. The rotor may be rotated relative to the stator using the rotatable drive, allowing the connecting elements of the rotor to establish fluidic connections between different ports of the stator.

One port of the injection valve 10 may have a fluidic connection 9 to one port of the pre-column switching valve 13. Another port of the injection valve 10 may have a fluidic connection 11 to the reconditioning pump 12. The port of the injection valve 10 which may have a fluidic connection 9 to one port of the pre-column switching valve 13, and the port of the injection valve 10 which may have a fluidic connection 11 to the reconditioning pump 12 may be fluidly connected by means of the connecting elements of the injection valve 10 in the configuration of FIG. 2. Furthermore, one port or a plurality of further ports of the injection valve 10 may have a fluidic connection to one or a plurality of sample reservoirs (not depicted) containing one or a plurality of samples (not depicted).

One port of the pre-column switching valve 13 may have a fluidic connection 4 to the separation pump 1; another port of the pre-column switching valve 13 may have a fluidic connection to the first separation column 8; another port of the pre-column switching valve 13 may have a fluidic connection to the second separation column 5.

One port of the post-column switching valve 7 may have a fluidic connection 6 to the detector 22; another port of the post-column switching valve 7 may have a fluidic connection to the first separation column 8; another port of the post-column switching valve 7 may have a fluidic connection to the second separation column 5; another port of the post-column switching valve 7 may have a fluidic connection to a waste (not depicted).

The configuration assumed by the pre-column switching valve 13 and by the post-column switching valve 7 may determine the fluidic connection between different elements of the chromatography system, or, in other words, the configuration of the liquid chromatography system. In particular, the configuration of the connecting elements of the pre-column switching valve 13 and of the post-column switching valve 7 determines the configuration of the liquid chromatography system.

As an example, in FIG. 2, an embodiment the liquid chromatography system is depicted, according to the present invention, in a first configuration I of a normal operation mode.

The port of the pre-column switching valve 13, which may have a fluidic connection to a port of the injection valve 10, and the port of the pre-column switching valve 13, which may have a fluidic connection to the second separation column 5, may be fluidly connected by means of the connecting elements of the pre-column switching valve 13 in the first configuration I. The port of the pre-column switching valve 13, which may have a fluidic connection to the separation pump 1, and the port of the pre-column switching valve 13, which may have a fluidic connection to the first separation column 8, may be fluidly connected by means of the connecting elements of the pre-column switching valve 13 in the first configuration I.

The port of the post-column switching valve 7, which may be have a fluidic connection to the first separation column 8, and the port of the post-column switching valve 7, which may have a fluidic connection to the detector 22, may be fluidly connected by means of the connecting elements of the post-column switching valve 7 in the first configuration I. The port of the post-column switching valve 7, which may be have a fluidic connection to the second separation column 5, and the port of the post-column switching valve 7, which may have a fluidic connection to the waste, may be fluidly connected by means of the connecting elements of the post-column switching valve 7 in the first configuration I.

The present invention, according a preferred embodiment, is at least in part directed to supplying a flow from the first separation column 8 into the detector 22 by means of the separation pump 1, in the first configuration I, as depicted in the preferred embodiment of FIG. 2. The first configuration I may be referred to as “first steady state”. In the first configuration I, the separation pump creates a flow from the first separation column 8 into the detector 22.

The present invention, according a preferred embodiment, is also at least in part directed to supplying a flow from the second separation column 5 into the waste by means of the reconditioning pump 12 in the first configuration I.

The method may further comprise the injection of a sample into the liquid chromatography system via the injection valve 10 and the pushing of the sample into the second separation column 5 by means of the reconditioning pump 12 in the first configuration I.

FIG. 3 depicts, as an example, a preferred embodiment of the system of FIG. 2 in a second configuration II of the normal operation mode. The second configuration II may interchangeably be referred to as first intermediate configuration.

The port of the pre-column switching valve 13, which may be have a fluidic connection to a port of the injection valve 10, and the port of the pre-column switching valve 13, which may have a fluidic connection to the first separation column 8, may be fluidly connected by means of the connecting elements of the pre-column switching valve 13 in the second configuration II. The port of the pre-column switching valve 13, which may be have a fluidic connection to the separation pump 1, and the port of the pre-column switching valve 13, which may have a fluidic connection to the second separation column 5, may be fluidly connected by means of the connecting elements of the pre-column switching valve 13 in the second configuration I.

The port of the post-column switching valve 13, which may be have a fluidic connection to the first separation column 8, and the port of the post-column switching valve 13, which may have a fluidic connection to the detector 22, may be fluidly connected by means of the connecting elements of the post-column switching valve in the second configuration II. The port of the post-column switching valve 13, which may be have a fluidic connection to the second separation column 5, and the port of the post-column switching valve 13, which may have a fluidic connection to the waste, may be fluidly connected by means of the connecting elements of the post-column switching valve 13 in the second configuration II.

The present invention is at least in part directed to supplying a flow from the first separation column 8 into the detector 22 by means of the reconditioning pump 12 in the second configuration II, as depicted in the preferred embodiment of FIG. 3. The second configuration II may be referred to as “first intermediate state”, wherein the reconditioning pump 12 creates a flow from the first separation column 8 into the detector 22.

The present invention is also at least in part directed to supplying a flow from the second separation column 5 into the waste by means of the separation pump 1 in the second configuration I as depicted in preferred the embodiment of FIG. 3.

The present invention is also at least in part directed to injecting a sample into the liquid chromatography system via the injection valve 10 and the pushing of the sample into the first separation column 8 by means of the reconditioning pump 12 in the second configuration II.

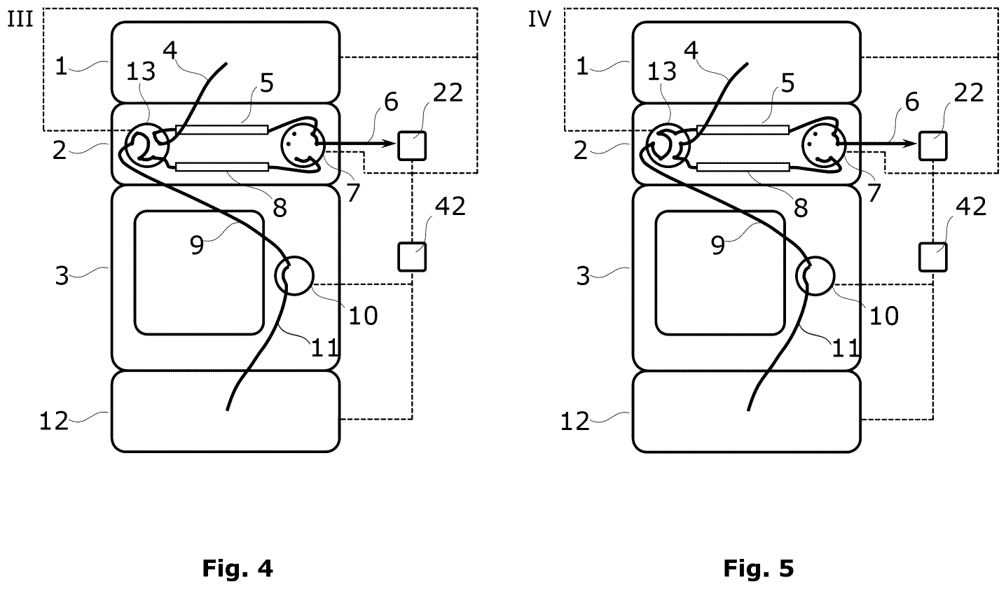

FIG. 4 depicts, as an example, a preferred embodiment of the system of FIG. 2 in a third configuration III of the normal operation mode. The third configuration III may interchangeably be referred to as second steady state configuration.

The port of the pre-column switching valve 13, which may be have a fluidic connection to a port of the injection valve 10, and the port of the pre-column switching valve 13, which may have a fluidic connection to the first separation column 8, may be fluidly connected by means of the connecting elements of the pre-column switching valve 13 in the third configuration. The port of the pre-column switching valve 13, which may be have a fluidic connection to the separation pump 1, and the port of the pre-column switching valve 13, which may have a fluidic connection to the second separation column, may be fluidly connected by means of the connecting elements of the pre-column switching valve 13 in the third configuration III.

The port of the post-column switching valve 13, which may be have a fluidic connection to the first separation column 8, and the port of the post-column switching valve 13, which may have a fluidic connection to the waste, may be fluidly connected by means of the connecting elements of the post-column switching valve 13 in the third configuration III. The port of the post-column switching valve 13, which may be have a fluidic connection to the second separation column 5, and the port of the post-column switching valve 13, which may have a fluidic connection to the detector 22, may be fluidly connected by means of the connecting elements of the post-column switching valve 13 in the third configuration III.

The present invention is at least in part directed to supplying a flow from the first separation column 8 into the waste by means of the reconditioning pump 12 in the third configuration III, as depicted in the preferred embodiment of FIG. 3.

The present invention is also at least in part directed to supplying a flow from the second separation column 5 into the detector 22 by means of the separation pump 1 in the third configuration III, as depicted in the preferred embodiment of FIG. 3. The third configuration III may be referred to as “second steady state”, wherein the separation pump 1 creates a flow from the second separation column 5 into the detector 22.

The present invention is also at least in part directed to injecting a sample into the liquid chromatography system via the injection valve 10 and the pushing of the sample into the first separation column 8 by means of the reconditioning pump 12 in the third configuration III.

FIG. 5 depicts, as an example, a preferred embodiment of the system of FIG. 2 in a fourth configuration IV of the normal operation mode. The fourth configuration IV may interchangeably be referred to as second intermediate configuration.

The port of the pre-column switching valve 13, which may be have a fluidic connection to a port of the injection valve 10, and the port of the pre-column switching valve, which may have a fluidic connection to the second separation column 5, may be fluidly connected by means of the connecting elements of the pre-column switching valve 13 in the fourth configuration IV. The port of the pre-column switching valve 13, which may be have a fluidic connection to the separation pump 1, and the port of the pre-column switching valve 13, which may have a fluidic connection to the first separation column 8, may be fluidly connected by means of the connecting elements of the pre-column switching valve 13 in fourth configuration IV.

The port of the post-column switching valve 13, which may be have a fluidic connection to the first separation column 8, and the port of the post-column switching valve 13, which may have a fluidic connection to the waste, may be fluidly connected by means of the connecting elements of the post-column switching valve 13 in the fourth configuration IV. The port of the post-column switching valve 13, which may be have a fluidic connection to the second separation column 5, and the port of the post-column switching valve 13, which may have a fluidic connection to the detector 22, may be fluidly connected by means of the connecting elements of the post-column switching valve 13 in the fourth configuration III.

The present invention is at least in part directed to supplying a flow from the first separation column 8 into the waste by means of the separation pump 1 in the fourth configuration IV, as depicted in the preferred embodiment of FIG. 4.

The present invention is also at least in part directed to supplying a flow from the second separation column 5 into the detector 22 by means of the reconditioning pump 12 in the fourth configuration IV, as depicted in the preferred embodiment of FIG. 4. The fourth configuration IV may be referred to as “second intermediate state”, wherein the reconditioning pump 12 creates a flow from the second separation column 5 into the detector 22.

The present invention is also at least in part directed to injecting of a sample into the liquid chromatography system via the injection valve 10 and the pushing of the sample into the second separation column 5 by means of the reconditioning pump 12 in the fourth configuration IV.

Furthermore, as depicted in FIGS. 2 to 5, the system may also comprise a controller 42. The controller 42 can be operatively connected to other components, as depicted by dashed lines in FIGS. 2 to 5. For instance, the controller 42 may be operatively connected to the reconditioning pump 12, to the injection valve 10, to the detector 22, to the post-column switching valve 7, to any component that may serve, at least in part, a similar purpose to the column switching valve 7, to the separation pump 1 and to the pre-column switching valve 13. The controller 42 can include a data processing unit and may be configured to control the system and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

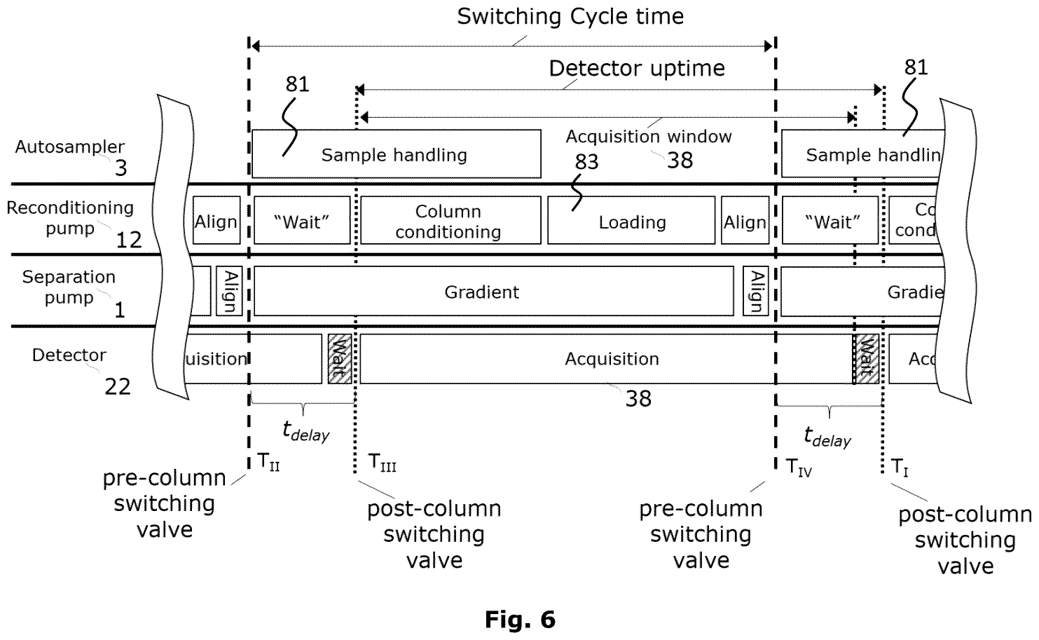

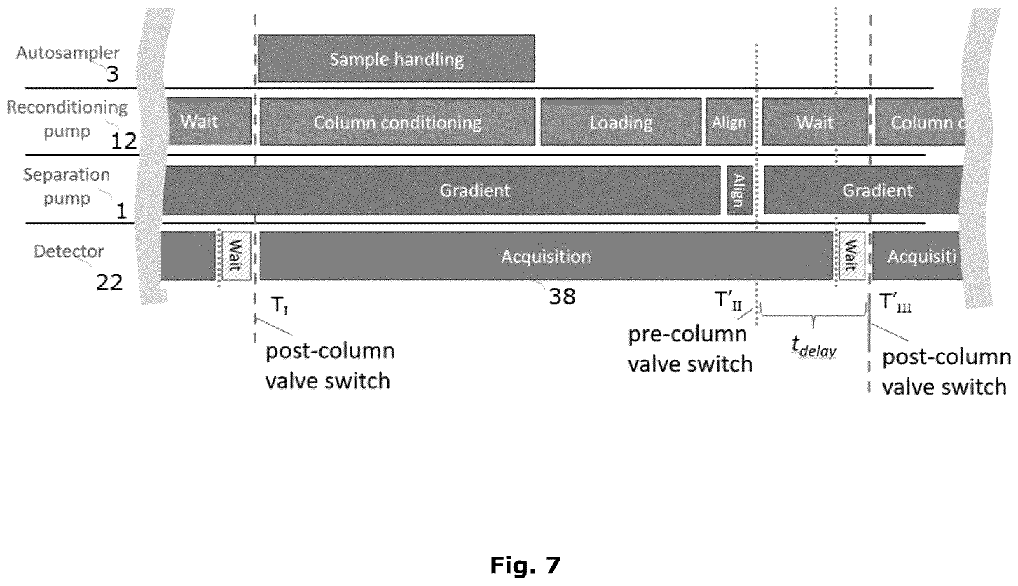

FIG. 6 depicts an exemplary visualization of a workflow of a tandem liquid chromatography system with optimized acquisition time window based on four configurations of a liquid chromatography system in a normal operation mode.

The present invention is at least in part directed to using a tandem direct injection workflow of a liquid chromatography system with optimized elution time window and optimized detection time window, based on the four configurations of the preferred embodiments of FIG. 2 to FIG. 5.

In particular, the elution window and the window for detector data acquisition may be aligned such, that consistent, reproducible chromatograms are obtained at optimum throughput, without relevant portions of the chromatogram being lost. This approach may be particularly beneficial with regard to tandem LC applications.

More in particular, four moments in time may be significant: a first switching time T_{II}, a second switching time T_{III}, a third switching time T_{IV} and a fourth switching time T_{I}, wherein T_{I} is later than T_{IV}, which is later than T_{III}, which is later than T_{II}. The system may be switched from the first configuration I to the second configuration II at the first switching time T_{II}. The system may be switched from the second configuration II to the third configuration III at the second switching time T_{III}. The system may be switched from the third configuration III to the fourth configuration IV the third switching time T_{IV}. The system may be switched from the fourth configuration IV back to the first configuration I at the fourth switching time T_{I}. In other words, the invention relates to a process where the system is switched among four configurations. The process may be a cyclic process, i.e. a process that repeats itself.

The system, in particular, may be switched from a “steady” state of the first configuration I to an “intermediate” state of the second configuration II, and subsequently to a “steady” state of the third configuration III, and subsequently to an “intermediate” state of the fourth configuration IV. It will be understood that a “steady” state of the liquid chromatography system (i.e., a steady state configuration of the liquid chromatography system) can identify a state where the separation pump 1 provides a flow, via the first 8 or the second separation column 4, into the detector. It will also be understood that a “intermediate” state of the liquid chromatography (i.e., an intermediate configuration of the liquid chromatography system) can identify a state where the reconditioning pump 12 provides a flow, via the first 8 or the second separation column 4, into the detector.

The time difference between T_{III} and T_{II} may be identified with t_{delay}. The time difference between T_{I} and T_{IV} may also be identified with t_{delay}.

With regard to the preferred embodiment of FIG. 6, the liquid chromatography system is intended to be in the first configuration I right before T_{II}. At T_{II} the pre-column switching valve 13 can switch the system from the first configuration I to the second configuration II. At T_{II}, a fluidic connection between the separation pump 1, the second separation column 5 and the waste can be achieved.

In other words, at T_{II}, the pre-column switching valve 13 may be switched to direct the gradient flow, which is simultaneously started, to the freshly conditioned second separation column 5. Simultaneously, the reconditioning pump 12 may deliver the last fraction of the gradient, that may have been generated by the separation pump 1 in a preceding step in the cycle through the first separation column 5, towards the post-column switching valve 7 where it may be directed towards the detector 22. There the compounds which may have been eluted from this last fraction of the gradient can be detected. During this phase, the flow rate of the reconditioning pump 12 may preferably be identical to the gradient flow rate of the separation pump 1, to assure consistent flow of the gradient solvents to the detector 22.

The separation pump 1 can start providing a gradient at T_{II}, thereby starting an elution window. However, the detector may not start a new acquisition window 38 yet. This is due to the fact that the gradient, started at T_{II}, may need an amount of time to traverse the fluidic connections between the separation pump 1 and the second separation column 5, and further to traverse the second separation column 5.

At T_{II}, furthermore, a fluidic connection between the reconditioning pump 12, the autosampler 3, the first separation column 8 and the detector 22 can be achieved.

The reconditioning pump 12 can provide a flow from the first separation column 8 into the detector 22. During this stage, which may be called “Wait”, the reconditioning pump 12 can push contents of the first separation column 8 into the detector 22. The flow rate of the reconditioning, during this stage, can be the same as the separation pump. The detector 22 may not start a new acquisition window 38 at T_{II}, but rather continue detecting in a previous acquisition window, and, in particular, continue detecting the flow from the first separation column 8 provided my means of the reconditioning pump 12. The detector can also stop detecting after T_{II} and before T_{III}, thereby ending the previous acquisition window, and wait to start a new acquisition window until T_{III}.

At T_{III} the post-column switching valve 7 can switch the system from the second configuration II to the third configuration III.

At T_{III}, a fluidic connection between the separation pump 1, the second separation column 5 and the detector 22 can be achieved.

The separation pump 1 may have started providing the gradient at T_{II}. Therefore, at T_{III}, the gradient provided by the separation pump may have had the time to traverse the fluidic connections between the separation pump 1 and the second separation column 5, and further the second separation column 5, and further the fluidic connection between the second separation column 5 and the detector 22. Therefore, at T_{III}, the detector 22 may start detecting in an acquisition window 38.

At T_{III}, furthermore, a fluidic connection between the reconditioning pump 12, the autosampler 3, the first separation column 8 and the waste can be achieved.

The reconditioning pump 12 can provide a flow from the first separation column 8 into the waste. During this stage, the reconditioning pump 12 conditions the first separation column 8. The flow rate of the reconditioning pump 12, during this stage, can be the larger than the separation pump 1.

Injecting a sample into the liquid chromatography system may start at T_{II} and may stop after T_{III} and before T_{IV}.

The autosampler 3 may carry a “sample handling” process 81. The sample handling process may for example comprise preparing a sample for loading 83 into the LC system. For example, a needle (not depicted) of the LC system may be aligned with a reservoir containing the sample and the autosampler 3 may be operated to draw the sample from the reservoir. Afterwards, the reconditioning pump 12 may be used for loading 83 the drawn sample into the LC system. During a cycle, two sample handling processes 81 may respectively initiate at T_{II} and at T_{IV}, i.e., when the system is switched to the first and to the second intermediate configurations (as illustrated in FIG. 6). However, this is merely exemplary. The sample handling processes 81 may also start at or after T_{II} and at T_{IV}, respectively. For example, the sample handling processes 81 for a cycle may start at or after T_{III} and T_{I} respectively.

In other words, at T_{III}, which may be at t_{delay} after T_{II}, the post-column switching valve 7 may switch and the flow from the second separation column 5, which may contain solvent at a gradient start condition (for example, 16), may be directed towards the detector 22. In the case of the reconditioning pump 12, at timepoint at T_{III}, which may be at t_{delay} after T_{II}, the reconditioning pump 12 will have delivered the last fraction of the gradient representing the gradient end concentration (for example, 17) through the post-column switching valve 7 towards the detector 22. It may now start conditioning the first separation column 8. To this, the flow of the reconditioning pump 12 may be increased to speed up washing and equilibration of the first separation column 8. At the post-column switching valve 7 the flow may be directed towards a waste container.

At T_{IV} the pre-column switching valve 13 can switch the system from the third configuration III to the fourth configuration IV.

At T_{IV}, a fluidic connection between the separation pump 1, the first separation column 8 and the waste can be achieved.

The separation pump 1 can start providing the gradient at T_{Iv}, thereby starting an elution window. However, the detector may not start a new acquisition window yet. This is due to the fact that the gradient may need an amount of time to traverse the fluidic connections between the separation pump 1 and the first separation column 8, and further to traverse the first separation column 8.

At T_{IV}, furthermore, a fluidic connection between the reconditioning pump 12, the autosampler 3, the second separation column 5 and the detector 22 can be achieved.

The reconditioning pump 12 can provide a flow from the second separation column 5 into the detector 22. During this stage, which may be called “Wait”, the reconditioning pump 12 can push the contents of second separation column 5 into the detector 22.

In other words, the last fraction of the gradient, provided by the separation pump 1 into the second separation column 5 starting from T_{II}, can be eluted into the detector by the reconditioning pump 12 starting from T_{IV}. The flow rate of the reconditioning pump 12, during this stage, can be the same as the separation pump 1.

The detector 22 may not start a new acquisition window at T_{IV}, but rather continue detecting, and, in particular, continue detecting the flow from the second separation column 5 provided my means of the reconditioning pump 12. In other words, the detector 22 may continue detecting the last fraction of the gradient, provided by the separation pump 1 into the second separation column 5 the starting from T_{II}. The detector can also stop detecting after T_{IV}, thereby ending the acquisition window 38, and before T_{I} and wait to start a new acquisition window until T_{I}.

At T_{I} the post-column switching valve 7 can switch the system from the fourth configuration IV back to the first configuration I.

At T_{I}, a fluidic connection between the separation pump 1, the first separation column 8 and the detector 22 can be achieved.

The separation pump 1 can start providing the gradient at T_{IV}. Therefore, at T_{I}, the gradient provided by the separation pump 1 may have had the time to traverse the fluidic connections between the separation pump 1 and the first separation column 8, and further the first separation column 8, and further the fluidic connection between the first separation column 8 and the detector 22. Therefore, at T_{I}, the detector 22 may start detecting in a new acquisition window.

At T_{I}, furthermore, a fluidic connection between the reconditioning pump 12, the autosampler 3, the second separation column 5 and the waste can be achieved.

The reconditioning pump 12 can provide a flow from the second separation column 5 into the waste. During this stage, the reconditioning pump 12 conditions the second separation column 5. The flow rate of the reconditioning pump 12, during this stage, can be the larger than the separation pump 1. It will be understood that the autosampler 3 may start injecting a sample into the liquid chromatography system at T_{I}.

It will be understood that the system, after T_{I}, can repeat the process described in relation to the embodiment of FIG. 6 in a periodic manner, switching from the first configuration I to the second configuration II at a time T_{II}′, which is later than T_{I}. In other words, a cyclic process may be realized by system, wherein the system is switched among four configurations.

The subsequent cycle follows the same temporal sequence such that times T_{II}′, T_{III}′, T_{IV}′, T_{I}′ of the subsequent cycle correspond, respectively, to the times T_{II}, T_{III}, T_{IV}, T, in terms of temporal as well as functional characteristics.

The present invention is furthermore at least in part directed to optimizing the time difference t_{delay} between T_{III} and T_{II}, and between T_{I} and T_{IV}. The optimization of the time difference t_{delay} can lead, for example in a tandem chromatography system, to consistent and reproducible chromatograms, where a single detection window can contain only and all of the chromatographic peaks of a single compound and/or group of compounds of interest. The optimization of the time difference t_{delay} can further lead, for example in a tandem chromatography system, to an optimum throughput of the tandem chromatography system.

In other words, because of the optimized delay between T_{III} and T_{II}, and between T_{I} and T_{IV}, the detector widow of acquisition can be optimally aligned with respect to the time when the single compound and/or group of compounds of interest reach the detector.

Generally, embodiments of the present invention may be described as follows. FIG. 2 depicts a liquid chromatography system in a first configuration I. In this configuration, the separation pump 1 is connected to the first separation column 8 and further to the detector 22. Furthermore, the reconditioning pump 12 is fluidly connected to the second separation column 5 and to a waste (not depicted in FIG. 1). This is a “normal” or steady state, where the second separation column 5 may be reconditioned and the separation pump 1 may provide a gradient to the first separation column 8 and further to the detector 22.

It will be understood that FIG. 4 depicts another “normal” or steady state, where the separation pump 1 is connected to the second separation column 5 and to the detector 22, and the reconditioning pump 12 is connected to the first separation column 8 and to the waste.

Embodiments of the present invention are directed in that the system additionally also assumes the state or configuration II depicted in FIG. 3 and/or IV depicted in FIG. 5. In the configuration II in FIG. 3, the reconditioning pump 12, which may also be referred to as second pump 12, is connected to the first separation column 8 to the detector 22. That is, different to the configurations I and III depicted in FIGS. 2 and 4, the system also assumes a configuration, wherein the second pump 12 is connected to the detector.

The system is switched from the configuration I in FIG. 2 to the configuration II in FIG. 2 at a first switching time T_{II}, the index denoting the configuration the system is switched to. At the first switching time T_{II}, it is preferred that the solvent composition and the flow rate delivered by the second pump 12 is identical to the one delivered by the separation pump 1. It will be understood that the flow rate and solvent composition should be identical as delivered at the pre-column switching valve 13, as this is where the change of the fluidic connections becomes effective.

As discussed above, there generally is a time delay t_{delay} between when a certain solvent composition is present at the separation pump 1 (as part of a gradient operation) and when this solvent composition arrives at the detector 22. In embodiments of the present invention, the system is operated in the configuration II of FIG. 3 for a duration corresponding to this time delay t_{delay}. That is, for a duration t_{delay}, fluid is delivered from the first separation column 8 to the detector 22 by means of the second pump 12.

This is also depicted in FIG. 6. According to this Figure, the pre-column switching valve 13 is switched at time T_{II}. Subsequently, for the time delay t_{delay}, the reconditioning pump 12 “waits”, i.e., is used to effect a flow from the first separation column 8 to the detector 22. During this time, there is data acquisition and a short wait time at the detector 22.

Once the last part of the gradient has reached the detector 22, the system is switched from the configuration II in FIG. 3 to the configuration III in FIG. 4. In this configuration, the first separation column 8 is connected to the reconditioning pump 12 and to the waste. Further, the second separation column 5 is connected to the separation pump 12 and to the detector 22. Relating to the separation column 5, reference is again made to the configuration II of FIG. 3. In this configuration II, the second separation column 5 is already connected to the separation pump 1. However, it is not yet connected to the detector 22, but to the waste. In this configuration, the separation pump 1 may start its gradient delivery (see FIG. 6 at the first switching time T_{II}). Again, it will be understood that a solvent composition provided by the separation pump at a certain point of time will only reach downstream components later. In particular, this solvent composition at the start of the gradient delivery may take approximately the time delay t_{delay} to reach the post-column switching valve. Only at this point of time, the solvent present at the post-column switching valve may be of interest for further detection. Thus, at the second switching time T_{III}, which is the time delay t_{delay} later than the first switching time T_{II}, the system may be switched from the second configuration II of FIG. 3 to the third configuration III of FIG. 4. At this time, a new data acquisition time window may start (see 38 in FIG. 6), which corresponds to the gradient delivered by the separation pump 1 arriving at the detector 22.

Furthermore, it will be appreciated that in the configuration III of FIG. 4, the first separation column 8 is no longer connected to the detector 22, but to waste. In this configuration, the first separation column 8 may thus be reconditioned. This is depicted in FIG. 6, where, staring at the third switching time T_{III}, the reconditioning pump 12 provides a column reconditioning. It should be understood that this column reconditioning may be performed with flow rates different from the flow rate delivered during the gradient delivery. In particular, it may be performed with higher flow rates. After the first separation column 8 has been reconditioned, it may be loaded with another sample. Further, the reconditioning pump 12 may perform an aligning step before the third switching time T_{IV}.

In this regard, it will be understood that the fourth configuration IV depicted in FIG. 5 essentially corresponds to the second configuration II depicted in FIG. 3, but with reversed roles for the first separation column 8 and the second separation column 5. Again, the second separation column 5, in the configuration III assumed before configuration IV, is connected to the separation pump 1 and to the detector 22. In the configuration IV (see FIG. 5), the second separation column 5 is still connected to the detector 22, but no longer to the separation pump 1, but instead to the reconditioning pump 12. Similar to the configuration in FIG. 3, the reconditioning pump 12 effects the last sections of the gradient to flow from the second separation column 5 to the detector 22. Again, it may be beneficial if the operational parameters of the solvent provided a the third switching time T_{IV}, i.e., when the system switches to configuration IV depicted in FIG. 5, are identical for the separation pump 1 and the second pump 12, which may also be referred to as reconditioning pump 12. Again, it will be understood that when switching to the fourth configuration IV in FIG. 5, the reconditioning pump 12 takes over the function of the separation pump 1 in configuration IV. It is thus beneficial for the operational parameters (in particular flow rate and solvent composition) to be identical at the switching time T_{IV}. This is why prior to the switching time T_{IV} (see FIG. 6), the reconditioning pump 12 and the separation pump 1 are aligned with one another, meaning that there operational parameters are identical at the switching time T_{IV}. At T_{IV}, the pre-column switching valve is switched, such that the configuration IV of FIG. 5 is assumed.

Again, this configuration IV essentially corresponds to the configuration II of FIG. 3, with the roles of the separation columns 5 and 8 reversed. It will thus be understood that at a fourth switching time T_{I}, the system may again switch to configuration I depicted in FIG. 2 and that the overall operation be cyclical between the configurations I, II, III, and IV.

With regard to FIG. 6, the following considerations will be appreciated. Firstly, as described, the fluid is caused to arrive at the detector 22 both by the separation pump 1 and the reconditioning pump 12 (see boxes indicating with “wait” for the reconditioning pump 12 in FIG. 6 and configurations II and IV, where the reconditioning pump 12 is connected to the detector 22). Secondly, the acquisition time windows 38 are shifted with regard to the gradient delivery of the separation pump 1 (see FIG. 6) to account for time delay t_{delay} between a certain solvent composition being delivered by the pump and arriving at the detector 22.

Overall, embodiments of the present technology thus allow for an increased usage time of the described system. In particular, the detector 22 may be supplied with solvents containing samples a higher percentage of the time as compared to other configurations. Further, by shifting the data acquisition time windows, signals may be more correctly assigned to a certain sample than is possible without such a shift.

FIG. 7 depicts an exemplary visualization of a workflow of a tandem liquid chromatography system with optimized acquisition time window based on four configurations of a liquid chromatography system in a normal operation mode.

In normal tandem LC operation, all columns can operate within their normal operating conditions. Thus, while one column can be subjected to the actual chromatographic separation the other(s) are undergoing conditioning steps such as column washing, equilibration as well as sample loading.

For example, the workflow of FIG. 7 may be a continuation of the workflow in FIG. 6. In other words, the workflow depicted in FIG. 7, may be a subsequent cycle of the normal operation mode following the one illustrated in FIG. 7.

That is, as explained, in FIG. 6 the cycle may end at the fourth switching T_{I} wherein the system is switched from the fourth configuration back to the first configuration. The system may then be in the first configuration I until a subsequent switch to the second configuration at the switching time T′_{II}. The system can then be maintained in the second configuration until a subsequent switch to the third configuration at switching time T′_{III}.

It will be appreciated that the sample handling process may also start before T_{I}, as illustrated in FIG. 6.

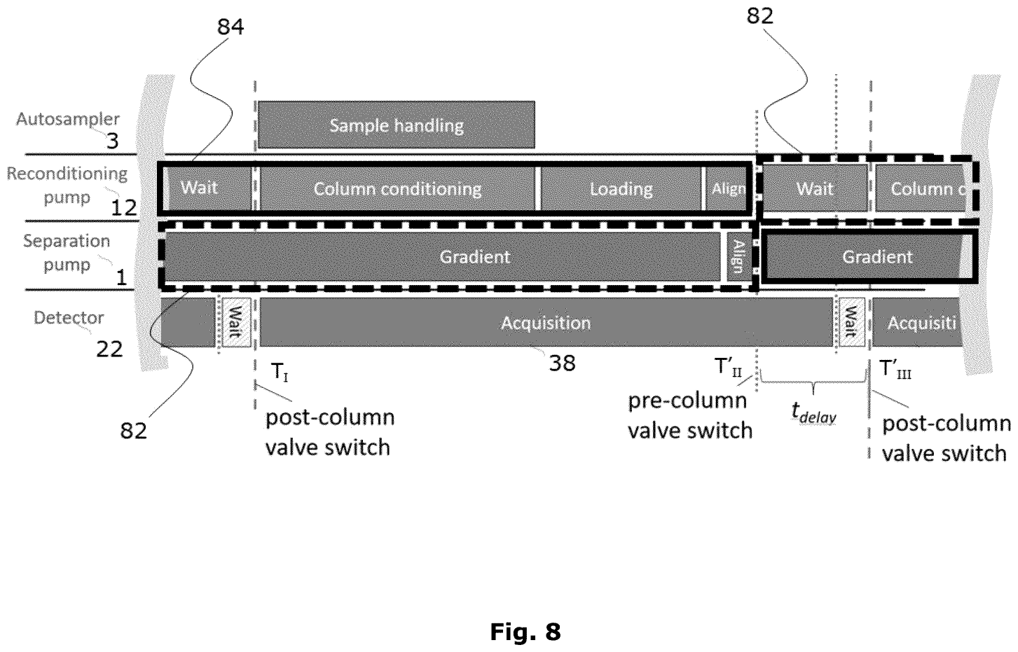

FIG. 8 illustrates the workflow of FIG. 7 wherein one of the columns becomes non-operational. In particular, as depicted by the interrupted bold outline 82, the column provided with the gradient before switching time T′_{II}, may become non-operational. This may be due to a failover activation event. The other column, however, may still be operational, as depicted by the bold outline 84.

The failover activation event can be triggered based on at least one predefined decision criterion. The at least one predefined decision criterion may be based on any set of system parameters configured to be indicative that the LC system is operational when any of the system parameters is within a respective predefined range and configured to be indicative of a compromised LC system when one or more of the system parameters exceeds the respective predefined range.

The at least one predefined decision criterion may comprise a threshold value for the column resistance, a pressure value during gradient operation. In its simplest form the at least one predefined decision criterion may be a pressure threshold value. Thus, if the pump or column pressure during gradient operation exceeds (or falls below) this threshold value, this can be indicative of a problematic column state. This may be originating from a blockage due to agglomeration of particulates or due to bleeding of column material (i.e. loss of solid phase). To this a user may preferably define a threshold value. This value can preferably be lower than the system's maximum pressure, e.g.,

$${P}_{threshold} < {P}_{system , max} - 100 bar .$$

The pressure or resistance value can be advantageous because they can be straightforward to evaluate. Alternatively or additionally, the chromatographic performance may also be evaluated, e.g., by analyzing the actual chromatogram data (such as, peak shape and/or retention time), and based thereon the failover activation event may be triggered. Exemplary means for performance monitoring of an analytical system, that can be utilized by the present invention, have been described, for example, in DE 10 2019 111782 A1.

The failover activation event is graphically illustrated in FIG. 8. The separation column that is subjected to the gradient is no longer operational, as indicated by the interrupted bold outline 82 (e.g. as the column pressure has exceeded the threshold pressure). However, the yet functional other column, as indicated by the bold outline 84, can still undergo column conditioning and sample loading.

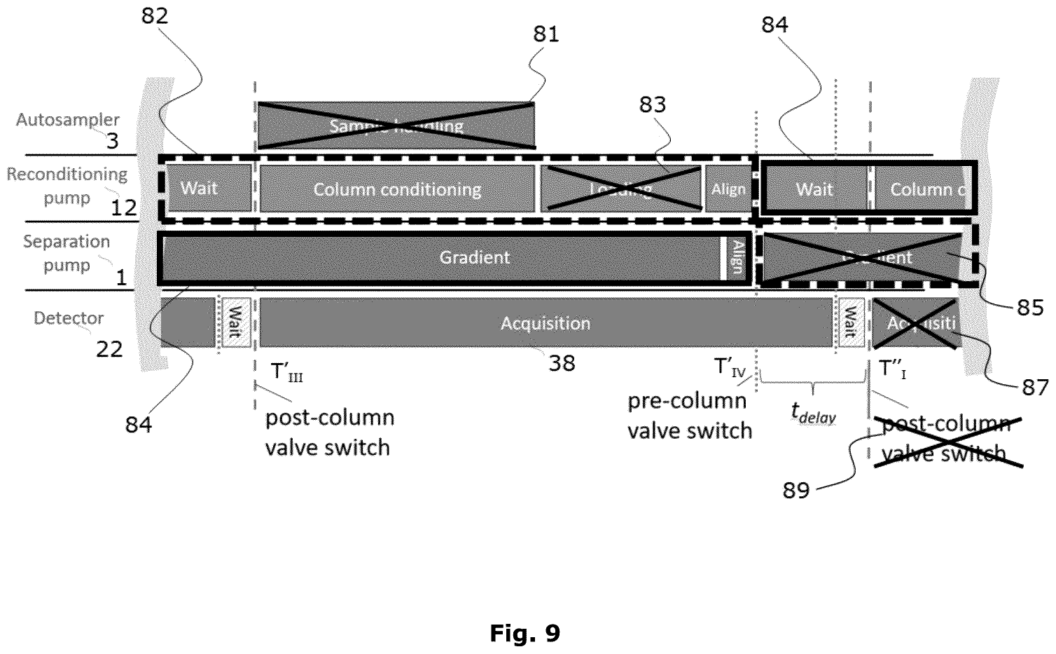

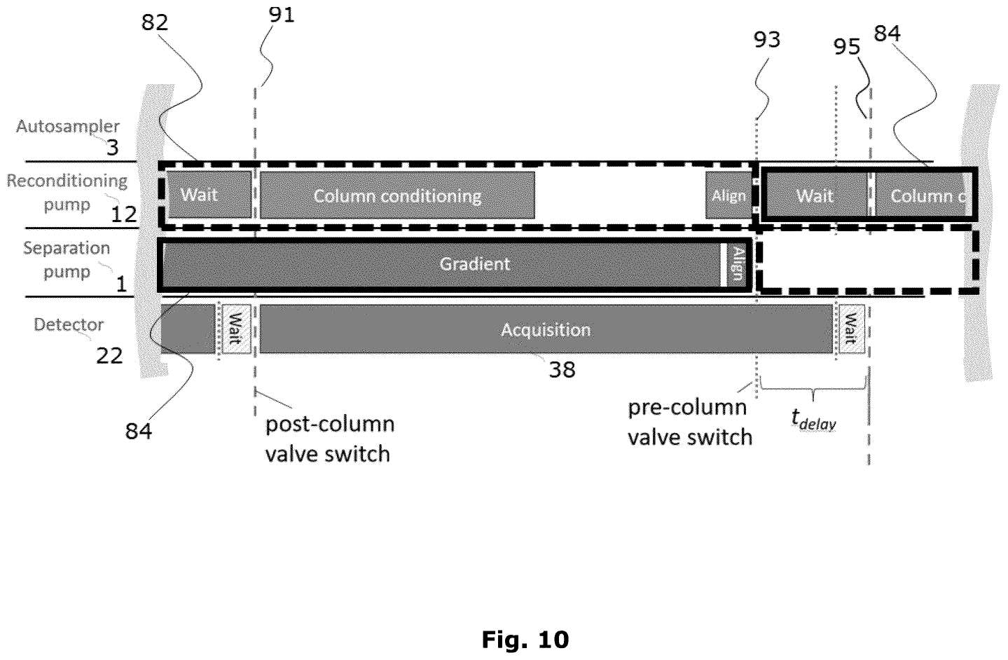

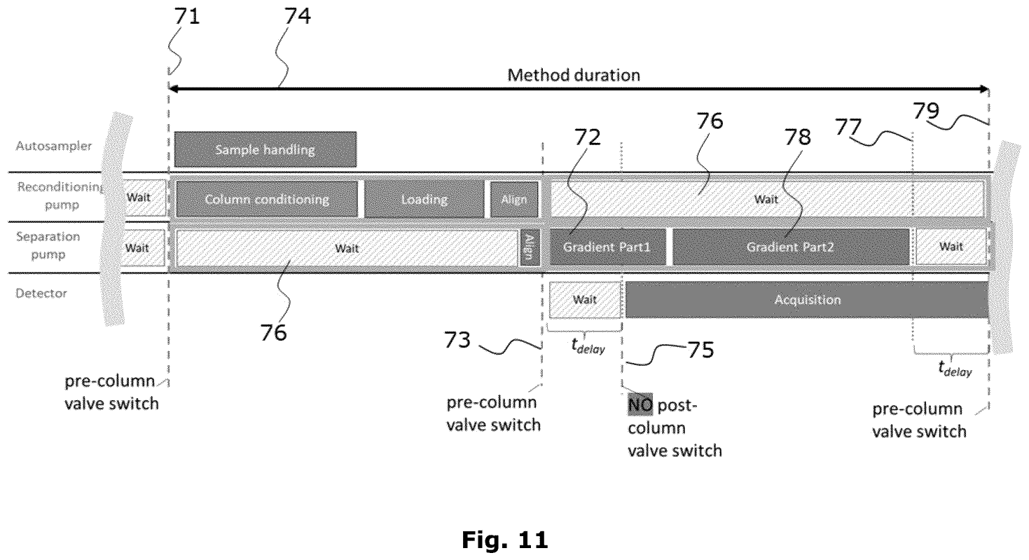

FIGS. 9 and 10 illustrates an intermediate failover operation mode of the LC system. The LC system may be operated in the intermediate failover operation mode, after detecting the failover activation event and before operating the system in the failover activation mode. That is, the intermediate failover operation mode may be a transitory operation mode between the normal operation mode (discussed with respect to FIGS. 1 to 7) and the failover activation mode illustrated in FIG. 11.

The system may transition into the failover operation mode at time failover start time 71.

The intermediate failover operation mode may be configured to complete any processes or cycles of the normal operation mode ongoing during the detection of the failover activation event. This can be advantageous for a safe and seamless transition from the normal operation mode to the failover operation mode.

In particular, FIG. 9 illustrates the workflow of the normal operation mode following the one in FIG. 7 (see the common switching time T′_{III}, depicted at the end of the workflow in FIG. 7 and at the start of the workflow in FIG. 9).

As depicted by the crosses, the sample handling process 81, the loading process 83, the provision of a gradient 85 at T′_{IV}, the post-column valve switch 89 at T″_{I} and the start of acquisition 87 at T″_{I} are skipped. That is, whereas said processes 81, 83, 85 and 87 would normally be performed under the normal operation mode, in the failover operation mode they are skipped.

FIG. 10 illustrates the processes performed during the intermediate failover operation mode.

Operating the liquid chromatography system in the intermediate failover operation mode may comprise operating the liquid chromatography system in a first intermediate failover configuration, wherein the separation pump can be fluidly connected to the operational column and can be operated to supply a flow from the operational column to the detector and wherein the second pump can be fluidly connected to the non-operational column and can be operated to supply a flow from the non-operational column to a waste. The system may switch to the first intermediate failover operation at time 91.

In the intermediate failover operation mode, the system may be switched, at a first intermediate failover switching time 93, from the first failover configuration to a second intermediate failover configuration. The system may be operated in the second intermediate failover configuration until a second intermediate failover switching time 95. In the second intermediate failover configuration, the second pump can be fluidly connected to the operational column and preferably can be operated to supply a flow from the operational column to the detector and the separation pump can be fluidly connected to the non-operational column and can preferably be operated in a predetermined controlled mode.

The intermediate failover operation mode may last until the second intermediate failover switching time 95. More particularly, the system may be operated in the intermediate failover operation mode from the detection of the failover activation event until the second intermediate failover switching time 95.

The intermediate failover operation mode may be particularly advantageous to prevent loss of sample. This mode can be similar to the normal tandem LC operation with the exception that no sample pickup and loading is performed. If the intermediate failover operation mode would be omitted, the sample which would have been loaded during normal operation (and thus simultaneously to the occurrence of the failover activation event (i.e. during the gradient step)), would be washed off the column right away during the initial phase of the failover operation mode when this yet operational and freshly loaded column is subjected to a column wash (see FIG. 11). Hence, the sample would be lost.

FIG. 11 illustrates a failover operation mode and in particular a failover cycle 74 thereof.

Operating the liquid chromatography system in the failover operation mode comprises operating the liquid chromatography system in a first failover configuration, switching, at a first failover switching time 73, the liquid chromatography system from the first failover configuration to a second failover configuration and operating the liquid chromatography system in the second failover configuration until a second failover switching time 79.

Thus, the system is in the first failover configuration before the first failover switching time 73 and in the second failover configuration between the first failover switching time 73 and the second failover switching time 79.

In the second failover switching time 79, the system may be switched back to the first failover configuration. Thus, operating the liquid chromatography system in the failover operation mode may comprise cyclically switching between the first and the second failover configuration.

In the first failover configuration, the separation pump can be fluidly connected to the non-operational column and can be operated in a predetermined controlled mode 76. The predetermined controlled mode 76 may be a pressure-controlled mode, in which a pressure in the non-operational column is controlled, preferably maintained constant. Moreover, in the first failover configuration, the second pump can be fluidly connected to the operational column and can be operated to supply a flow from the operational column to a waste.

In the second failover configuration, the second pump can be fluidically connected to the non-operational column and can be operated in the predetermined controlled mode 76 and the separation pump can be fluidly connected to the operational column and can be operated to supply a flow from the operational column to the detector.

Operating the separation pump in the second failover configuration to supply a flow from the operational column to the detector can comprise starting the provision of a mobile phase at the first failover switching time 73 and stopping the provision of the mobile phase at a flow stopping time 77. The flow stopping time 77 can be before the second failover switching time 79. A time a time difference between the second failover switching time 79 and the flow stopping time 77 can depend on a volume of the operational column, on a volume of fluidic connections connected to the operational column, and on a flow rate of the separation pump.

Operating the separation pump in the second failover configuration to supply a flow from the operational column to the detector can comprise providing a gradient, which can be a two-part process comprising providing a first gradient 72 and providing a second gradient 78. That is, the mobile phase can be provided via a first gradient 72 and a second gradient 78.

It is noted that during the failover operation mode, a fluidic connection between the operational column and the detector may be maintained. In other words, in the failover operation mode forming a fluidic connection between the non-operational column and the detector may be avoided. Thus, in the failover operation mode there may be no post-column valve switches.

The detector 22 can be maintained switched off during the first failover configuration. The detector 22 can be activated at a detector activation time 75, which can be after the after the first failover switching time 73. A time difference between the first failover switching time 73 and the detector activation time 75 can depend on a volume of the operational column, on a volume of fluidic connections connected to the operational column, and on a flow rate of the separation pump.

The first and second failover configurations can thus be similar to the first and second steady state configurations of the normal operation mode, with the exception that the pumps are operated in a predetermined controlled mode 76 when connected to the non-operational column.

In the failover mode the roles of both pumps may remain unchained. Thus, one pump (i.e., the second pump) can used for column conditioning and loading, while the other pump (i.e., the separation pump) can perform the actual chromatographic separation (i.e. the gradient delivery). Since in a two-column LC system there can be only one operational column left, after one becoming non-operational, those processes can be performed sequentially rather than in parallel. Hence, the workflow in the failover operation mode can be similar to a non-tandem direct injection workflow. During phases where one pump subjects flow to the yet operational column, the other pump can be operated in a pressure-controlled mode (e.g. constant pressure), delivering flow to the non-operational column (as indicated by the “Wait” mode 76). The constant pressure operation may allow to continue operating the tandem workflow on the yet functional column irrespective of the flow that may yet be delivered to the non-operational column. Thus, in the worst case when the non-operational column is blocked entirely, the flow may even be zero.

Whenever a relative term, such as “about”, “substantially”, “essentially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method in a liquid chromatography system comprising a first separation column, a second separation column, a separation pump upstream the separation columns and a detector downstream the separation columns, the method comprising:
detecting a failover activation event relating to one of the separation columns, said separation column being a non-operational column, while the other an operational column;
operating the liquid chromatography system in a failover operation mode, after detecting the failover activation event;
wherein operating the liquid chromatography system in the failover operation mode comprises:
allowing a fluid connection between the separation pump, the operational column and the detector and
preventing a fluid connection between the non-operational column and the detector.

2. The method of claim 1, wherein detecting the failover activation event comprises detecting a pressure value of one of the separation columns exceeding a predefined pressure range.

3. The method of claim 1, wherein operating the liquid chromatography system in the failover operation mode comprises loading samples into the operational column and preventing loading samples into the non-operational column.

4. The method of claim 1, wherein in the failover operation mode, the non-operational column is fluidly connected to a waste downstream the non-operational column and the operational column is fluidly connected to the detector.

5. The method according of claim 1, wherein operating the liquid chromatography system in the failover operation mode comprises
operating the liquid chromatography system in a first failover configuration;
switching, at a first failover switching time, the liquid chromatography system from the first failover configuration to a second failover configuration;
operating the liquid chromatography system in the second failover configuration until a second failover switching time;

6. The method of claim 5, further comprising
switching, at the second failover switching time, the liquid chromatography system from the second failover configuration to the first failover configuration;
wherein operating the liquid chromatography system in the failover operation mode comprises cyclically switching between the first and the second failover configuration.

7. The method of claim 5,
wherein in the first failover configuration, the separation pump is fluidly connected to the non-operational column and is operated in a predetermined controlled mode;
wherein in the second failover configuration, the separation pump is fluidly connected to the operational column and is operated to supply a flow from the operational column to the detector.

8. The method of claim 7,
wherein operating the separation pump in the second failover configuration to supply a flow from the operational column to the detector comprises starting the provision of a mobile phase at the first failover switching time;
wherein in the second failover configuration, the method comprises stopping the provision of the mobile phase at a flow stopping time;
wherein the flow stopping time is before the second failover switching time;
wherein a time difference between the second failover switching time and the flow stopping time depends on a volume of the operational column, on a volume of fluidic connections connected to the operational column, and on a flow rate of the separation pump.

9. The method of claim 5,
wherein the method comprises deactivating the detector in the first failover configuration;
wherein the method comprises activating the detector in the second failover configuration at a detector activation time;
wherein the detector activation time is after the first failover switching time;
wherein a time difference between the first failover switching time and the detector activation time depends on a volume of the operational column, on a volume of fluidic connections connected to the operational column, and on a flow rate of the separation pump.

10. The method of claim 5,
wherein the liquid chromatography system comprises a second pump upstream the separation columns;
wherein in the first failover configuration, the second pump is fluidly connected to the operational column and is operated to supply a flow from the operational column to a waste;
wherein in the second failover configuration, the second pump is fluidly connected to the non-operational column and is operated in the predetermined controlled mode.

11. The method of claim 1, wherein the method comprises operating the liquid chromatography system in an intermediate failover operation mode after detecting the failover activation event;
wherein operating the liquid chromatography system in the intermediate failover operation mode comprises:
operating the liquid chromatography system in a first intermediate failover configuration;
switching, at a first intermediate failover switching time, the liquid chromatography system from the first failover configuration to a second intermediate failover configuration;
operating the liquid chromatography system in the second intermediate failover configuration until a second intermediate failover switching time

12. The method of claim 11, wherein
in the first intermediate failover configuration, the separation pump is fluidly connected to the operational column and is operated to supply a flow from the operational column to the detector and
in the second intermediate failover configuration, the separation pump is fluidly connected to the non-operational column and is operated in a predetermined controlled mode.

13. The method of claim 12,
wherein the liquid chromatography system comprises a second pump upstream the separation columns;
wherein in the first intermediate failover configuration, the second pump is fluidly connected to the non-operational column and is operated to supply a flow from the non-operational column to a waste;
wherein in the second intermediate failover configuration, the second pump is fluidly connected to the operational column and is operated to supply a flow from the operational column to the detector.

14. The method of claim 1, wherein the method comprises operating the liquid chromatography system in a normal operation mode prior to detecting the failover activation event.

15. The method of claim 14,
wherein the liquid chromatography system comprises a second pump upstream the separation columns;
wherein operating the liquid chromatography system in the normal operation mode comprises operating the liquid chromatography system in a first steady state configuration;
wherein in the first steady state configuration the first separation column is fluidly connected to the separation pump and to the detector and the separation pump is operated to supply a flow from the first separation column towards the detector;
wherein in the first steady state configuration, the second separation column is fluidly connected to the second pump and to a waste, and wherein the method further comprises supplying, with the second pump, a flow from the second separation column towards the waste;
wherein operating the liquid chromatography system in the normal operation mode comprises operating the liquid chromatography system in a second steady state configuration;
wherein in the second steady state configuration the second separation column is fluidly connected to the separation pump and to the detector, and the separation pump is operated to supply a flow from the second separation column towards the detector;
wherein in the second steady state configuration, the first separation column is fluidly connected to the second pump and to a waste, and wherein the method further comprises supplying, with the second pump, a flow from the first separation column towards the waste.

16. The method of claim 15,
wherein the method comprises operating the liquid chromatography in a first intermediate configuration;
wherein in the first intermediate configuration, the first separation column is fluidly connected to a second pump and to the detector, and the second pump is operated to supply a flow from the first separation column towards the detector;
wherein in the first intermediate configuration, the second separation column is fluidly connected to the separation pump and to a waste, and the method comprises supplying a flow, with the separation pump, from the second separation column towards the waste;
wherein the method comprises operating the liquid chromatography in a second intermediate configuration;
wherein in the second intermediate configuration, the second separation column is fluidly connected to a second pump and to the detector, and the second pump is operated to supply a flow from the second separation column towards the detector;
wherein in the second intermediate configuration, the first separation column is fluidly connected to the separation pump and to a waste, and the method comprises supplying a flow, with the separation pump, from the first separation column towards the waste.

17. The method of claim 16,
wherein the method comprises switching the liquid chromatography system from the first steady state configuration to the first intermediate configuration at a first switching time;
wherein the method comprises switching the liquid chromatography system from the first intermediate configuration to the second steady state configuration at a second switching time;
wherein the method comprises switching the liquid chromatography system from the second steady state configuration to the second intermediate configuration at a third switching time;
wherein the method comprises switching the liquid chromatography system from the second intermediate configuration to the first first-state configuration at a fourth switching time;
wherein the normal operation mode is a cyclic process and wherein for each cycle the method comprises performing the switches performed at the first, second, third and fourth switching time.

18. The method of claim 16,
wherein the method comprises operating the liquid chromatography system in the first intermediate configuration for a first intermediate duration, wherein the first intermediate duration depends on a volume of the second separation column, on a volume of fluidic connections connected to the second separation column, and on a flow rate of the separation pump;
wherein the method comprises operating the liquid chromatography system in the second intermediate configuration for a second intermediate duration, wherein the second intermediate duration depends on a volume of the first separation column, on a volume of fluidic connections connected to the first separation column, and on a flow rate of the separation pump.

19. The method of claim 1, wherein the method comprises
carrying out an analytical process with the liquid chromatography system and generating an analytical result;
determining at least one deviation between the analytical result and a reference result; and
wherein detecting the failover activation event comprises detecting the at least one deviation exceeding a predefined deviation range.

20. A system for liquid chromatography, the system comprising:
a first separation column,
a second separation column,
a separation pump upstream the separation columns and
a detector downstream the separation columns;
wherein the system is configured to carry out the method of claim 1.
